(19) United States
(12) Patent Application Publication
(10) Pub. No.: US 2025/0321994 A1
(43) Pub. Date: Oct. 16, 2025

(54) SYSTEMS AND METHODS FOR APPLYING LANGUAGE MODELS AS SUPER AGENTS IN SOFTWARE APPLICATIONS

(71) Applicant: Nexa AI, Cupertino, CA (US)

(72) Inventors: Wei CHEN, Cupertino, CA (US); Zhiyuan LI, Cupertino, CA (US)

(21) Appl. No.: 19/060,498

(22) Filed: Feb. 21, 2025

Related U.S. Application Data
(60) Provisional application No. 63/633,798, filed on Apr. 14, 2024.

(51) Int. Cl. G06F 16/3329; G06F 40/30

(52) U.S. Cl. CPC G06F 16/33295; G06F 40/30

(57) ABSTRACT

This application is directed to implementing functions at a computer system automatically. The computer system receives a natural language query. In response to the natural language query, the computer system automatically applies a function determination model to generate function information of a target function based on the natural language query. The function information further includes identification information and one or more parameters of the target function. The target function is implemented based on the function information. One or more user applications are configured to implement a plurality of predefined functions including the target function.

### RELATED APPLICATION

This application claims benefit of U.S. Provisional Patent Application No. 63/633,798, filed Apr. 14, 2024, titled “Octopus v2: On-device Language Model for Super Agent,” which is incorporated by reference in its entirety.

### TECHNICAL FIELD

The present invention generally relates to the field of artificial intelligence (AI) technology and, more particularly, to methods, systems, devices, and non-transitory computer-readable storage medium for converting natural language queries to executable computer functions of software programs using language models.

### BACKGROUND

Applying large language models (LLMs) have been applied in software development presents. LLMs can accelerate coding by generating boilerplate code, suggesting solutions, or automating documentation. However, issues arise around accuracy and reliability, as LLMs may produce syntactically correct but logically flawed code or fail to understand complex system requirements, domain-specific contexts, or nuanced programming paradigms. Furthermore, programming latency is a significant drawback; complex queries, necessary context information, or extensive code generation may lead to delays in real-time development, disrupting the coding workflow, and reducing efficiency. Resource usage is another critical issue, as training and deploying LLMs require substantial computational power, which can increase costs, limit scalability, and create environmental concerns. Finally, integrating LLMs into workflows raises questions about maintainability, debugging, and the role of human oversight in ensuring quality and correctness.

### SUMMARY

Various embodiments of this application are directed to applying a language model to provide instructions or functions of a software program based on natural language queries. The natural language queries may be obtained and provided to the language model, which is trained and applied to determine the instructions or functions of the software program based on the natural language queries automatically. The instructions or functions are thereby implemented by the software program in response to the natural language queries. In some embodiments, the natural language queries are supplemented with context information (e.g., extracted from a database), and the context information is provided jointly with the natural language queries to the language model. Alternatively, in some embodiments, the language model has been pre-trained with the context information to generate predefined functions as functional tokens, and the natural language queries are provided to the language model with no or little query-specific context information in real time. In an example, the context information inputted to the language model is reduced by 95% for each query, and a programming latency is enhanced by 30 times compared with the embodiments in which the language model requires large amounts of context information be inputted jointly with queries. As such, the language model can act as a super-agent configured to determine a subsequent action, manage a workflow including a sequence of actions flexibly, and interact with its environment with a level of autonomy, reducing the latency to levels deemed suitable for deployment across a variety of edge devices in production environments.

In one aspect, a method is implemented at a computer system including one or more processors and memory to implementing executable functions automatically. The method includes receiving a natural language query. The method further includes, in response to the natural language query and automatically, applying a function determination model to generate function information of a target function based on the natural language query, and the function information further includes identification information and one or more parameters of the target function. The method further includes implementing the target function based on the function information. The one or more user applications are configured to implement a plurality of predefined functions including the target function.

In some embodiments, the computer system includes a client device that receives the natural language query. The method includes locally applying, by the client device, the function determination model to generate the function information associated with the target function. The function determination model includes an on-device language model implemented locally by the client device. Alternatively, in some embodiments, the computer system includes a client device that is communicatively coupled to a function server, and the natural language query is provided by the client device to the function server. The method includes applying, by the function server, the function determination model to generate the function information associated with the target function.

In some embodiments, the method includes tokenizing the target function's name and fine-tuning the function determination model with functional tokens representing the plurality of predefined functions. Fine-tuning with these tokens allows the function determination model to understand software application capabilities with the functional tokens, learning to map function descriptions to the functional tokens. During inference, the model uses functional tokens to achieve better performance in function calling compared to certain large language models (e.g., GPT-4). Under some circumstances, a large language model has 2 billion model parameters, and is fine-tuned to reduce 95% of a context length during model inference, which enables 70 times more function calls with the same battery and reduces the programming latency by approximately 35 times for each function call.

In another aspect, another method is performed at a server system including one or more processors and memory to implement executable functions automatically. The method includes obtaining a natural language query inputted from an electronic device that is configured to implement one or more user applications including a plurality of predefined functions. The plurality of predefined functions include a target function. The method further includes applying a function determination model to generate function information associated with the target function based on the natural language query, and the function information further includes identification information and one or more parameters of the target function. The method further includes providing the function information associated with the target function to a computer system for implementing the target function based on the function information

Some implementations of this application include a computer system that includes one or more processors and memory having instructions stored thereon, which when executed by the one or more processors cause the one or more processors to perform any of the above methods for implementing executable functions automatically.

Some implementations include a non-transitory computer readable storage medium storing one or more programs. The one or more programs include instructions, which when executed by one or more processors cause the processors to perform any of the above methods for implementing executable functions automatically.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

The foregoing summary, as well as the following detailed description of embodiments of the system and method for virtual-assistant-enhanced access of private information, will be better understood when read in conjunction with the appended drawings of an exemplary embodiment. It should be understood, however, that the invention is not limited to the precise arrangements and instrumentalities shown.

FIG. 1 is a block diagram illustrating an implementation of a computer system for calling a function of a software program using a natural language query, in accordance with some embodiments.

FIG. 2A is a structural diagram of an example neural network applied to process input data in a machine learning model, in accordance with some embodiments, and FIG. 2B is an example node in the neural network, in accordance with some embodiments.

FIG. 3 is a structural diagram of a language model formed in a transformer architecture, in accordance with some embodiments.

FIG. 4 is a block diagram of a machine learning system for training and applying a machine learning model, in accordance with some embodiments.

FIG. 5A is a block diagram of an example server (e.g., an application server, a function server, or a combination thereof), in accordance with some embodiments.

FIG. 5B is a block diagram of an example client device for interacting with a user to receive a natural language query, in accordance with some embodiments.

FIGS. 6A-6C illustrate three example automated workflows of calling functions based on natural language queries in a client device, in accordance with some embodiments.

FIG. 7A is a flow diagram of an example function prediction process implemented based on retrieval of function information, in accordance with some embodiments, and FIG. 7B is a flow diagram of another example function prediction process implemented based on functional tokens, in accordance with some embodiments.

FIG. 8 is a flow diagram of an example function calling process implemented by a computer system, in accordance with some embodiments.

FIG. 9 is a flow diagram of an example training data collection process implemented based on a foundation model, in accordance with some embodiments.

FIGS. 10A-10C are three example user interfaces showing functional tokens, in accordance with some embodiments.

FIGS. 11A and 11B are a flow diagram of an example method of implementing a function automatically at a computer system, in accordance with some embodiments.

FIG. 12 is a flow diagram of an example method of implementing a function automatically at a server, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

Various embodiments of this application are directed to applying a language model to provide instructions or functions of a software program based on natural language queries. The natural language queries may be obtained and provided to the language model, which is trained and applied to determine the instructions or functions of the software program based on the natural language queries automatically. The instructions or functions are thereby implemented by the software program in response to the natural language queries. In some embodiments, the language model has been pre-trained with context information (e.g., functional tokens, function description) to identify functional tokens representing predefined functions directly, and the natural language queries are provided to the language model with no or little query-specific context information. The language model acts as a super-agent configured to determine a subsequent action, manage a workflow including a sequence of actions flexibly, and interact with its environment with a level of autonomy, reducing the latency to levels deemed suitable for deployment across a variety of edge devices in production environments.

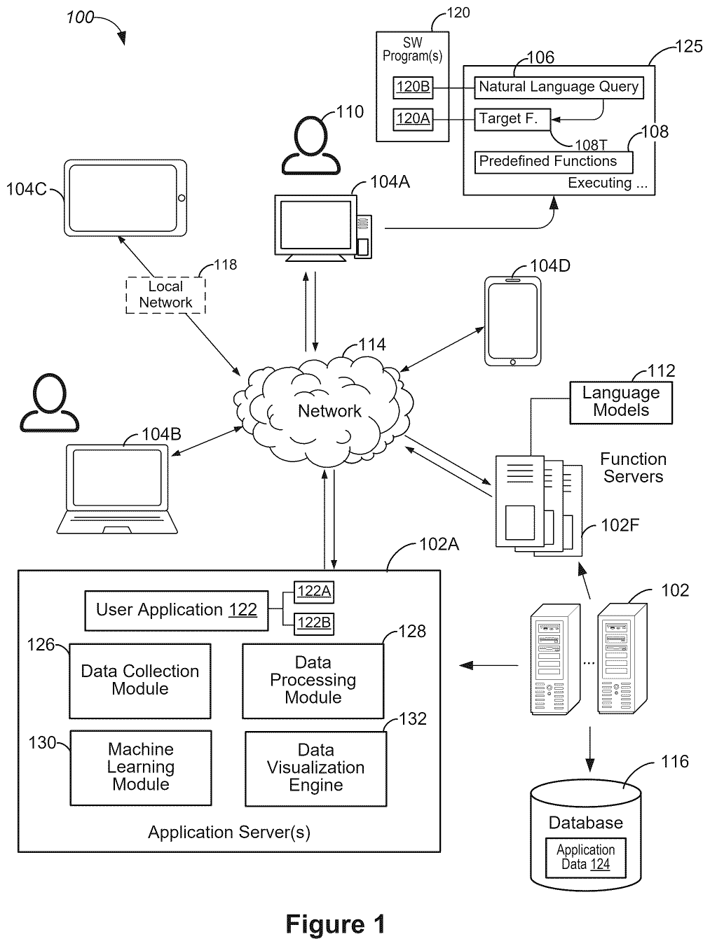

FIG. 1 is a block diagram illustrating an implementation of a computer system 100 for calling a function of a software program 120 using a natural language query 106, in accordance with some embodiments. While some example features are illustrated, various other features have not been illustrated for the sake of brevity and so as not to obscure pertinent aspects of the example embodiments disclosed herein. To that end, as a non-limiting example, the system for function calling, referred to herein as system 100, may include one or more client devices 104 in communication with one or more networked servers 102. The one or more networked servers 102 may share any number of logical units. In some embodiments, the system 100 is configured to receive a natural language query 106 at a client device 104 (e.g., a desktop computer 104A) associated with a user 110. In response to the natural language query 106, the system 100 determines and executes a target function 108T. In some embodiments, the target function 108T is associated with a first program 120A distinct from a second program 120B, which displays a user interface 125 and receives the natural language query 106. The second program 120B is configured to communicate with the first program 120A and call the target function 108T via an Application Programming Interface (API). Alternatively, in some embodiments, the natural language query 106 is received, and the target function 108T is called for the same first program 120A. In some embodiments, the target function 108T is selected from a plurality of predefined functions 108 associated with one or more software programs 120 (e.g., corresponding to one or more user applications 122).

In some embodiments, the system 100 includes one or more application servers 102A, one or more client devices 104, and one or more databases 116. Each application server 102A may be one or more computing servers that execute a respective user application 122 and provide secure access to application data 124 which may be stored on a database 116. In some situations, the second program 120B receiving the natural language query 106 corresponds to a respective user application 122. In some situations, the first program 120A associated with the target function 108T corresponds to a respective user application 122. For each application sever 102A, the user application 122 may have a plurality of user accounts associated with a plurality of users 110, who may log on to their user accounts via their respective client devices 104. In some embodiments, each application server 102A further includes one or more of a data collection module 126 for collecting a plurality of information items, a data processing module 128 for processing the plurality of information items 124, a machine learning module 130 for training and applying machine learning models (e.g., a language model identifying the target function 108T in response to a natural language query 106), and a data visualization engine 132 for presenting the plurality of information items on a user interface. In some embodiments, the database 116 may store application data 124 associated with one or more user applications 122 that are executed on the application servers 102A.

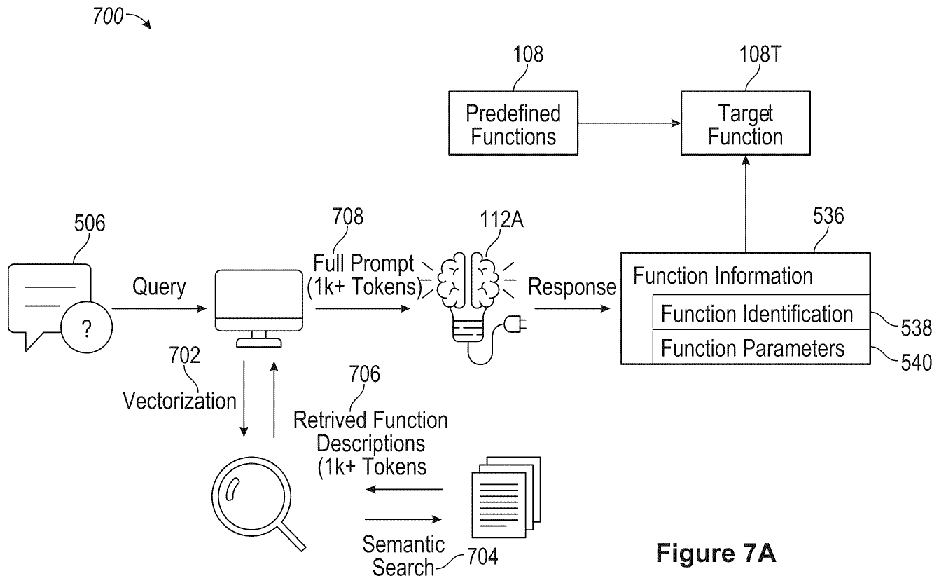

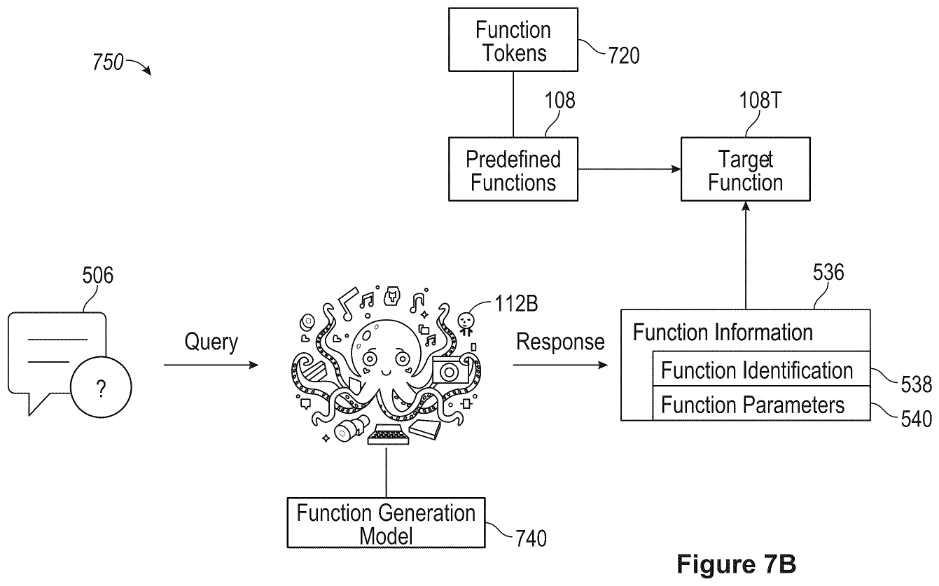

In some embodiments, the system includes a function server 102F configured to implement one or more language models 112 (e.g., a function determination model 740 in FIG. 7). The one or more language models 112 are trained and/or fine-tuned to process natural language queries 106 provided by the client devices 104 or the application server 102A, and determine function information identifying the functions 108 in response to the natural language queries 106. In some embodiments, a program 120 (e.g., program 120A or 120B) is executed at the client device 104A to obtain a natural language query 106 and provide it to the function server 102F. The function server 102 applies a language model 112 to process the natural language query 106, generate the function information associated with the target function 108T, and provide it to the client device 104A for execution by the first program 120A.

Alternatively, in some embodiments, both the client device 104A and the application servers 102A are involved in processing the natural language query 106 or implementing the target function 108T. After obtaining the natural language query 106 and generating the function information associated with the target function 108T, the function server 102F provides the function information to the corresponding application server 102A or the client device 104A for further implementation of the corresponding target function 108T. In an example, the application server 102A associated with the second program 120B may receive the function information from the function server 102F in response to the query 106, and pass the function information to an application server 102A associated with the first program 120A, which may receive the function information identifying the target function 108T, call the target function 108T, and continue to execute the first program 120A based on a result of the target function 108T. In another example, the application server 102A associated with the second program 120B may receive the function information from the function server 102F in response the query 106, and pass the function information to the client device 104A, which calls the target function 108T and continue to execute the first program 120A based on a result of the target function 108T.

In some embodiments, both the second program 120B receiving the query 106 and the language model(s) 112 are implemented locally at the client device 104A. The second program 120B may correspond to a program of an operating system or a user application 122B. A user interface 125 is displayed on the client device 104A to receive the natural language query 106. In response to the natural language query 106, the client device 104A applies the language model 112 to generate function information identifying the target function 108T based on the natural language query 106 and calls the target function 108T in the first program 120A, which may correspond to a respective user application 122A in some embodiments. In some implementations, the language model 112 is trained or fine-tuned at the function server 102F and deployed at the client device 104A. Further, in some embodiments, the language model 112 has a number of model parameters less than a threshold parameter number (e.g., 100 million), thereby allowing the language model 112 to be deployed and implemented at the client device 104A.

The one or more client devices 104 may be, for example, desktop computers 104A, laptop computers 104B, tablet computers 104C, mobile phones 104D, or any other computing devices. Each client device 104 can collect data or user inputs, executes a first program 120A, and present outputs on its user interface 125. The collected data or user inputs can be processed locally at the client device 104 and/or remotely by the server(s) 102. The application server 102A provides system data (e.g., boot files, operating system images, and user applications) to the client devices 104, and in some embodiments, processes the data and user inputs received from the client device(s) 104 when a user application 122 is executed on the client devices 104. In some embodiments, the database 116 stores data related to the application server 102A, client devices 104, and applications executed on the client devices 104.

The server 102 (e.g., servers 102A and 102F), one or more client devices 104 (e.g., devices 104A-104D), and databases 116 are communicatively coupled to each other via one or more communication networks 114, which are the medium used to provide communications links between these devices and computers connected together within the system 100. The one or more communication networks 114 may include connections, such as wire, wireless communication links, or fiber optic cables. Examples of the one or more communication networks 114 include local area networks (LAN), wide area networks (WAN) such as the Internet, or a combination thereof. The one or more communication networks 114 are, optionally, implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VOIP), Wi-MAX, or any other suitable communication protocol. A connection to the one or more communication networks 114 may be established either directly (e.g., using 3G/4G connectivity to a wireless carrier), or through a network interface 116 (e.g., a router, switch, gateway, hub, or an intelligent, dedicated whole-home control node), or through any combination thereof. As such, the one or more communication networks 114 can represent the Internet of a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages.

The servers 102 are configured to enable real-time data communication with the client devices 104 that are remote from each other or from the servers 102. Further, in some embodiments, the servers 102 are configured to implement data processing tasks that cannot be or are preferably not completed locally by the client devices 104. For example, a client device 104 includes a laptop computer 104B that applies machine learning models (e.g., a language model 112) having sizes not executable on the client device 104. In some embodiments, these machine learning models (e.g., large language model, information extraction model, natural language processing model) are created based on one or more neural networks to process the natural language queries 106 or application data 124 associated with a user application 122. A machine learning model may be trained with training data, e.g., at a function server 102F, before they are applied to process the natural language queries 106 or application data 124 for data inference.

Some implementations of this application include deployment of on-device language models 112, function calling via the language models 112, fine-turning and adaptation of the language models 112, or a combination thereof. In some embodiments, the language models 112 are deployed for local on-device implementation. Open-source models of manageable sizes, such as Gemma-2B, Gemma-7B, StableCode-3B, and Llama-7B, may be introduced and tuned to enhance associated inference speeds on a client device 104. In an example, a machine learning complier (MLC) LLM framework allows operation of Llama-7B language models on mobile phones 104D and other edge devices, demonstrating compatibility across various hardware, including AMD, NVIDIA, Apple, and Intel graphics processing units (GPUs). In some embodiments, function calling is made possible in smaller-scale language models 112, e.g., compared with an LLM having at least 100 million parameters, requiring 200 GBs to load, or trained with a large dataset. Llama-7B and Llama-13B based models can call predefined functions 108 corresponding to external application programming interfaces (APIs) with efficacy comparable to GPT-4. In some embodiments, an existing transformer-based LLM has hundreds of billions of parameters, possibly in the range of 170 billion to over a trillion, and a language model 112 has approximately 2 billion model parameters and is configured to generate a function in response to a model to perform on par with the existing transformer-based LLM. Retrieval-Augmented Generation (GAG) may be applied for function calling, where a model retrieves relevant functions from a large database based on the user's query 106 and a response is generated using these relevant functions as context information to be entered with the query 106 to a language model. In some embodiments, the language model 112 is fined tuned. For example, Low-Rank Adaptation (LoRA) is applied to train the language model 112 under GPU resource constraints. Model training and LoRA training are both applied and compared. LoRA enables extended functionalities in the associated language models 112.

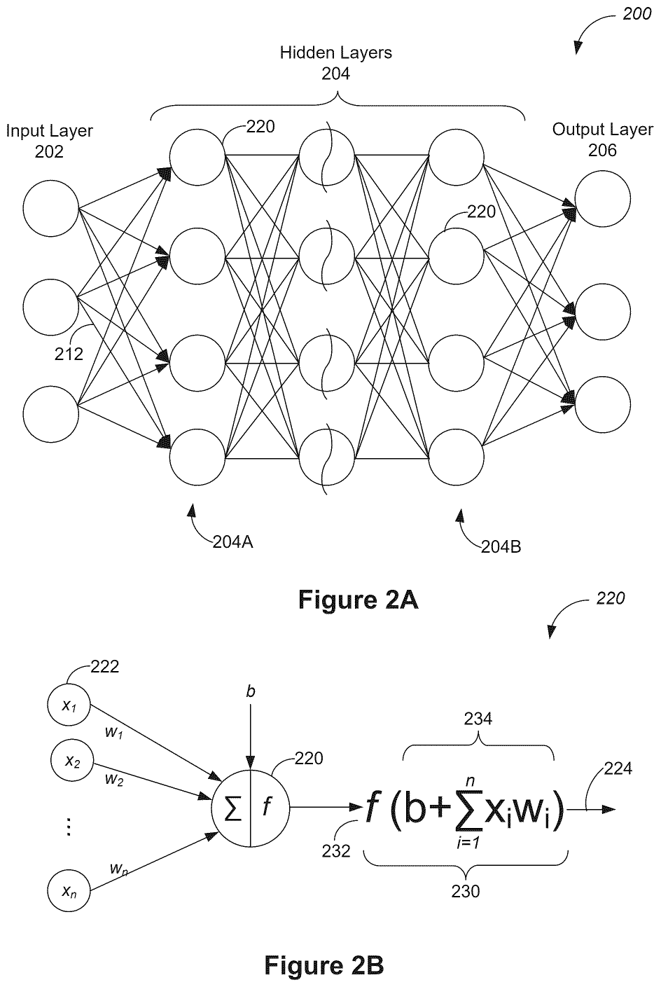

FIG. 2A is a structural diagram of an example neural network 200 applied to process input data in a machine learning model, in accordance with some embodiments, and FIG. 2B is an example node 220 in the neural network 200, in accordance with some embodiments. It should be noted that this description is used as an example only, and other types or configurations may be used to implement the embodiments described herein. The machine learning model is established based on the neural network 200. A corresponding machine learning module 130 (FIG. 1) or model-based processing module applies the machine learning model including the neural network 200 to process input data that has been converted to a predefined data format. The neural network 200 includes a collection of nodes 220 that are connected by links 212. Each node 220 receives one or more node inputs 222 and applies a propagation function 230 to generate a node output 224 from the one or more node inputs. As the node output 224 is provided via one or more links 212 to one or more other nodes 220, a weight w associated with each link 212 is applied to the node output 224. Likewise, the one or more node inputs 222 are combined based on corresponding weights w₁, w₂, w₃, and w₄ according to the propagation function 230. In an example, the propagation function 230 is computed by applying a non-linear activation function 232 to a linear weighted combination 234 of the one or more node inputs 222.

The collection of nodes 220 is organized into layers in the neural network 200. In general, the layers include an input layer 202 for receiving inputs, an output layer 206 for providing outputs, and one or more hidden layers 204 (e.g., layers 204A and 204B) between the input layer 202 and the output layer 206. A deep neural network has more than one hidden layer 204 between the input layer 202 and the output layer 206. In the neural network 200, each layer is only connected with its immediately preceding and/or immediately following layer. In some embodiments, a layer is a “fully connected” layer because each node in the layer is connected to every node in its immediately following layer. In some embodiments, a hidden layer 204 includes two or more nodes that are connected to the same node in its immediately following layer for down sampling or pooling the two or more nodes. In particular, max pooling uses a maximum value of the two or more nodes in the layer for generating the node of the immediately following layer.

In some embodiments, a convolutional neural network (CNN) is applied in a machine learning model to process input data (e.g., video and image data captured by cameras of a client device 104, a natural language query 106 in FIG. 1). The CNN employs convolution operations and belongs to a class of deep neural networks. The hidden layers 204 of the CNN include convolutional layers. Each node in a convolutional layer receives inputs from a receptive area associated with a previous layer (e.g., nine nodes). Each convolution layer uses a kernel to combine pixels in a respective area to generate outputs. For example, the kernel may be to a 3×3 matrix including weights applied to combine the pixels in the respective area surrounding each pixel. Video or image data is pre-processed to a predefined video/image format corresponding to the inputs of the CNN. In some embodiments, the pre-processed video or image data is abstracted by the CNN layers to form a respective feature map. In this way, video and image data can be processed by the CNN for video and image recognition or object detection.

In some embodiments, a recurrent neural network (RNN) is applied in the machine learning model to process input data. Nodes in successive layers of the RNN follow a temporal sequence, such that the RNN exhibits a temporal dynamic behavior. In an example, each node 220 of the RNN has a time-varying real-valued activation. It is noted that in some embodiments, two or more types of input data are processed by the data processing module 404, and two or more types of neural networks (e.g., both a CNN and an RNN) are applied in the same machine learning model to process the input data jointly.

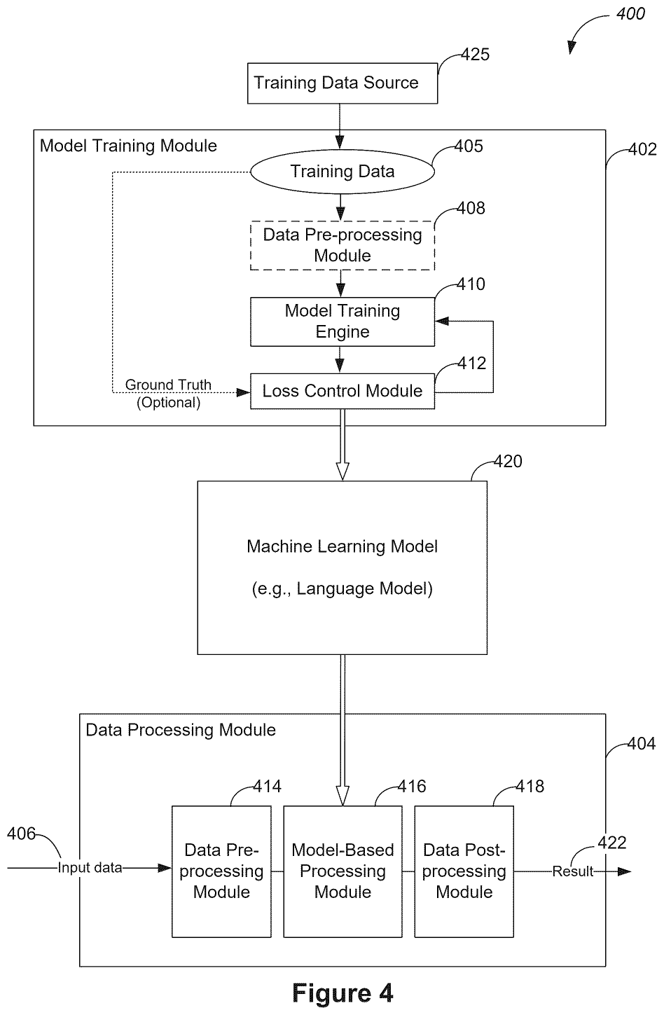

The training process is a process for calibrating all of the weights wᵢ for each layer of the neural network 200 using training data that is provided in the input layer 202. The training process typically includes two steps, forward propagation and backward propagation, which are repeated multiple times until a predefined convergence condition is satisfied. In the forward propagation, the set of weights for different layers are applied to the input data and intermediate results from the previous layers. In the backward propagation, a margin of error of the output (e.g., a loss function) is measured (e.g., by a loss control module 412 in FIG. 4), and the weights are adjusted accordingly to decrease the error. The activation function 232 can be linear, rectified linear, sigmoidal, hyperbolic tangent, or other types. In some embodiments, a network bias term b is added to the sum of the weighted outputs 234 from the previous layer before the activation function 232 is applied. The network bias b provides a perturbation that helps the neural network 200 avoid over fitting the training data. In some embodiments, the result of the training includes a network bias parameter b for each layer.

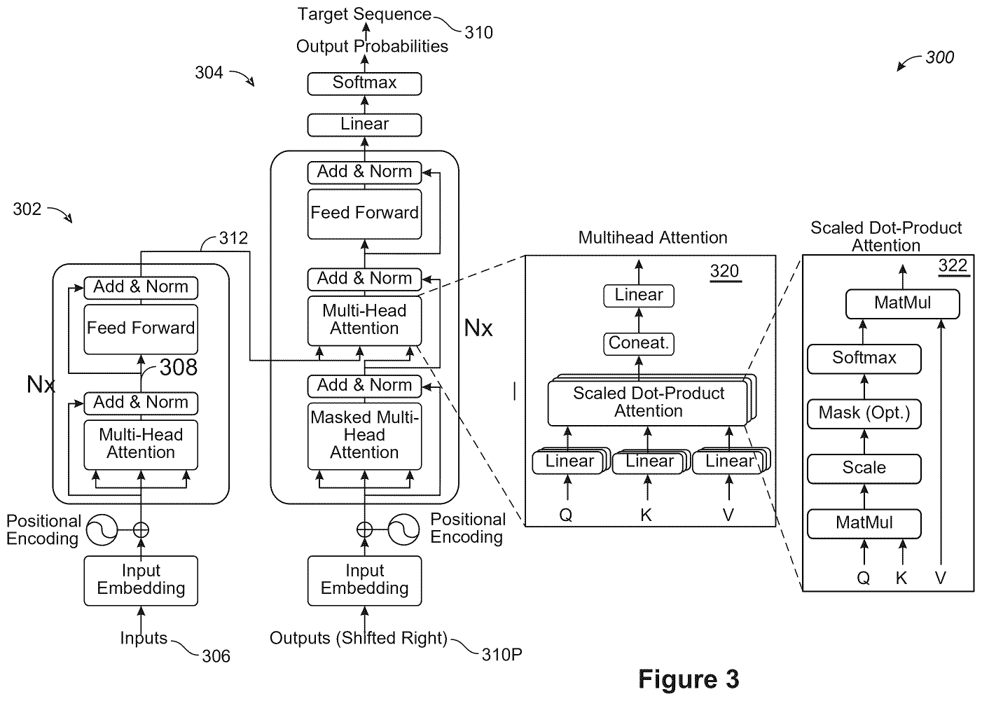

FIG. 3 is a structural diagram of a language model 300 formed in a transformer architecture, in accordance with some embodiments. Generative AI uses natural language processing (NLP) and machine learning to create natural language data or content. The language model 300 includes a deep learning neural network configured to perform natural language processing (NLP) tasks, e.g., text generation, summarization, translation, text classification, and answering questions, thereby enabling Generative AI. In some embodiments, the language model 300 includes an LLM. Compared with a normal language model, the LLM includes more than 100 million parameters, and is pre-trained with large corpora of text. In some embodiments, the language model 300 is implemented with a transformer architecture, and configured to shift through large datasets and recognize patterns and relationships between words or phrases. The transformer architecture includes an attention mechanism that weighs the importance of different words or phrases in a given context. In some embodiments, the language model 112 (FIG. 1) is implemented as an language model 300.

The transformer architecture of the language model 300 includes an encoder network 302 and a decoder network 304. The encoder network 302 is configured to receive an input sequence 306 and generate a sequence of hidden states 308. Each hidden state 308 includes a vector that encodes contextual information of a word in the input sequence 306 based on its relative position. The decoder network 304 is configured to receive portions 310P of a target sequence 310 successively and use an output 312 of the encoder network 302 to generate the target sequence 310. In some embodiments, the decoder network 304 starts with a starting token (e.g., “start”) and generates one prediction at a time. The decoder network 304 uses the output 312 produced by the encoder network 302 to understand the context of the input sequence 306. For each word of the target sequence 310 to be predicted, the decoder network 304 uses cross-attention mechanisms to focus on corresponding portions of the output 312 of the encoder network 302. As each word of the target sequence 310 is generated, the decoder network 304 updates its state and predicts a next word, until the entire target sequence 310 is generated.

In some embodiments, the language model 300 applies a self-attention mechanism, and each position in a sequence (e.g., a natural language query) is attended to all positions in the same sequence. Self-attention helps the language model 300 to understand and interpret the sequence by considering the entire sequence. For instance, when processing the natural language query, self-attention allows each word to be contextualized in relation to every other word in that natural language query. Alternatively, in some embodiments, the language model 300 applies a transformer architecture including multihead attention 320 (also called multihead self-attention). Each attention head 322 learns a respective attention mechanism so that multihead attention 320 as a whole can learn more complex relationships. For example, referring to FIG. 3, multihead attention 320 is applied in both the encoder network 302 and the decoder network 304 of the language model 300 implemented in the transformer architecture.

FIG. 4 is a block diagram of a machine learning system 400 for training and applying a machine learning model 420, in accordance with some embodiments. The machine learning system 400 includes a model training module 402 establishing one or more machine learning models 420 and a data processing module 404 for processing input data 406 using the machine learning model 420. For example, the machine learning model 420 includes a language model 112 applied to process a natural language query 106 and generate function information of a target function 108T to be implemented in a software program 120. In some embodiments, both the model training module 402 and the data processing module 404 are included within a machine learning module 128 of a server 102 or a client device 104, while a training data source 425 provides training data 405 to the server 102 or the client device 104. Alternatively, in some embodiments, the model training module 402 is located at the server 102, and the data processing module 404 is located in the client device 104. The server 102 trains the machine learning model 420 and provides the trained model 420 to the client device 104 to process input data 406 by the client device 104.

In some embodiments, the model training module 402 includes a model training engine 410 and a loss control module 412. Each machine learning model 420 is trained by the model training engine 410 to process corresponding input data 406 to generate a result 422 (e.g., function information of a target function 408T associated with a first program 120A in FIG. 1). The model training engine 410 receives the training data 405 corresponding to a machine learning model 420 to be trained, and processes the training data to build the machine learning model 420. In some embodiments, during this process, the loss control module 412 monitors a loss function comparing the output associated with the respective training data item to a ground truth of the respective training data item. In these embodiments, the model training engine 410 modifies the machine learning models 420 to reduce the loss, until the loss function satisfies a loss criteria (e.g., a comparison result of the loss function is minimized or reduced below a loss threshold). The machine learning models 420 are thereby trained and provided to a data processing module 404 to process input data 406 (e.g., natural language query 106).

In some embodiments, the model training module 402 further includes a data pre-processing module 408 configured to pre-process the training data 405 before the training data 405 is used by the model training engine 410 to train a machine learning model 420. For example, an image pre-processing module 408 is configured to format training images in the training data 405 into a predefined image format. For example, the preprocessing module 408 may normalize the training images to a fixed size, resolution, or contrast level. In another example, an image pre-processing module 408 extracts a region of interest (ROI) corresponding to an object in each training image or separates content of the object into a distinct image.

In some embodiments, the model training module 402 uses supervised learning in which the training data 405 is labelled and includes a desired output for each training data item (also called the ground truth in some situations). In some embodiments, the desirable output is labelled manually by people or labelled automatically by the model training module 402 before training. In some embodiments, the model training module 402 uses unsupervised learning in which the training data 405 are not labelled. The model training module 402 is configured to identify previously undetected patterns in the training data 405 without pre-existing labels and with little or no human supervision. Additionally, in some embodiments, the model training module 402 uses partially supervised learning in which the training data 405 is partially labelled.

In some embodiments, the data processing module 404 includes a data pre-processing module 414, a model-based processing module 416, and a data post-processing module 418. The data pre-processing modules 414 pre-processes input data 406 based on the type of the input data 406. In some embodiments, functions of the data pre-processing modules 414 are consistent with those of the pre-processing module 408, and convert the input data 406 into a predefined data format that is suitable for the inputs of the model-based processing module 416. The model-based processing module 416 applies the trained machine learning model 420 provided by the model training module 402 to process the pre-processed input data 406. In some embodiments, the model-based processing module 416 also monitors an error indicator to determine whether the input data 406 has been properly processed in the machine learning model 420.

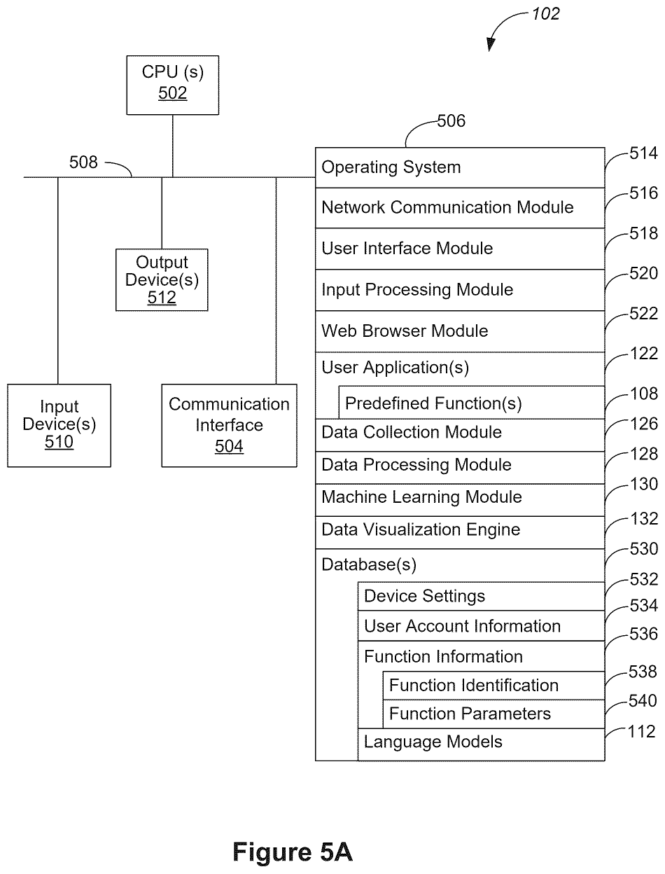

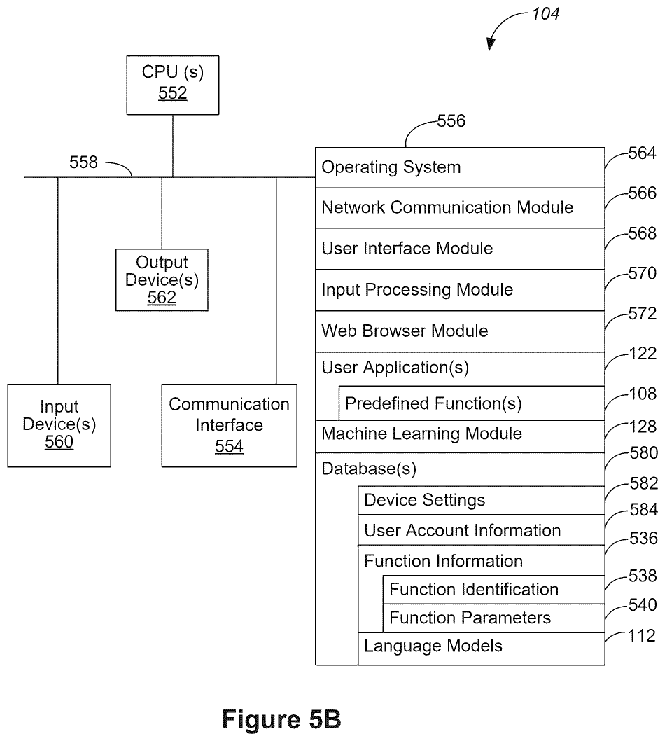

FIG. 5A is a block diagram of an example server 102 (e.g., an application server 102A, a function server 102F, or a combination thereof), in accordance with some embodiments. The server 102 may be coupled to, or include a database 116. The server 102 typically includes one or more processing units (e.g., CPUs) 502, one or more communication interfaces 504, memory 506, and one or more communication buses 508 for interconnecting these components (sometimes called a chipset). In some embodiments, the server 102 includes a user interface system that further includes one or more input devices 510 that facilitate user input or one or more output devices 512 including a display that enable presentation of user interfaces (e.g., interface 125 in FIG. 1) and display content.

Memory 506 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 506, optionally, includes one or more storage devices remotely located from one or more processing units 502. Memory 506, or alternatively the non-volatile memory within memory 506, includes a non-transitory computer readable storage medium. In some embodiments, memory 506, or the non-transitory computer readable storage medium of memory 506, stores the following programs, modules, and data structures, or a subset or superset thereof:
Operating system 514 including procedures for handling various basic system services and for performing hardware dependent tasks;
Network communication module 516 for connecting each server 102 to other devices (e.g., server 102, client device 104, or database 116) via one or more communication interfaces 504 (wired or wireless) and one or more communication networks 114 (FIG. 1), such as the Internet, other wide area networks, local area networks, metropolitan area networks, and so on;
User interface module 518 for enabling presentation of information (e.g., a graphical user interface for an application, widgets, websites and web pages thereof, and/or games, audio and/or video content, text, etc.) via one or more output devices 512 (e.g., displays, speakers, etc.);
Input processing module 520 for detecting one or more user inputs or interactions from one of the one or more input devices 510 and interpreting the detected input or interaction;
Web browser module 522 for navigating, requesting (e.g., via HTTP), and displaying websites and web pages thereof;
Server-side user application 122 for execution by the server 102 to collect or process application data 124, e.g., by calling one or more predefined functions 108;
Data collection module 126 for collecting a plurality of information items;
Data processing module 128 for processing the plurality of information items;
Machine learning module 130 for training and applying machine learning models 420 (e.g., a language model 112 applied determine a target function 108T in response to a natural language query 106);
Data visualization engine 132 for visualizing data on a user interface; and
One or more databases 530 for storing at least data including one or more of:
   Device settings 532 including common device settings (e.g., service tier, device model, storage capacity, processing capabilities, communication capabilities, etc.) of the server 102;
   User account information 534 for the user application 122, e.g., user names, security questions, account history data, user preferences, and predefined account settings;
   Function information 536 of predefined functions 108 called by user applications 122, e.g., including function identification 538 and one or more function parameters 540 of each predefined function 108; and
   One or more language models 112 (e.g., a function determination model applied to process a natural language query 106 to identify an executable target function 108T of a software program 120 (e.g., associated with a respective user application 122)).

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, memory 506, optionally, stores a subset of the modules and data structures identified above. Furthermore, memory 506, optionally, stores additional modules and data structures not described above.

FIG. 5B is a block diagram of an example client device 104 for interacting with a user 110 to receive a natural language query 106, in accordance with some embodiments. The client device 104 typically includes one or more processing units (e.g., CPUs) 552, one or more communication interfaces 554, memory 556, and one or more communication buses 558 for interconnecting these components (sometimes called a chipset). The client device 104 includes one or more input devices 560 that facilitate user input or one or more output devices 562 including a display that enables presentation of user interfaces and display content.

Memory 556 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 556, optionally, includes one or more storage devices remotely located from one or more processing units 552. Memory 556, or alternatively the non-volatile memory within memory 556, includes a non-transitory computer readable storage medium. In some embodiments, memory 556, or the non-transitory computer readable storage medium of memory 556, stores the following programs, modules, and data structures, or a subset or superset thereof:
Operating system 564 including procedures for handling various basic system services and for performing hardware dependent tasks;
Network communication module 566 for connecting each device 104 to other devices (e.g., server 102, client device 104, or database 116) via one or more communication interfaces 554 (wired or wireless) and one or more communication networks 114;
User interface module 568 for enabling presentation of information at each client device 104 via one or more output devices 562 (e.g., displays, speakers, etc.);
Input processing module 570 for detecting one or more user inputs or interactions from one of the one or more input devices 560 and interpreting the detected input or interaction;
Web browser module 572 for navigating, requesting (e.g., via HTTP), and displaying websites and web pages thereof;
Client-side user application 122 for execution by the client device 104 to collect or process application data 124, e.g., by calling one or more predefined functions 108;
Machine learning module 130 for training and applying machine learning models 420 (e.g., a language model 112 applied determine a target function 108T in response to a natural language query 106); and
One or more databases 580 for storing at least data including one or more of:
   Device settings 582 including common device settings (e.g., service tier, device model, storage capacity, processing capabilities, communication capabilities, etc.) of the client device 104;
   User account information 584 for the user application 122, e.g., user names, security questions, account history data, user preferences, and predefined account settings;
   Function information 536 of predefined functions 108 called by user applications 122, e.g., including function identification 538 and one or more function parameters 540 of each predefined function 108; and
   One or more language models 112 (e.g., a function determination model applied to process a natural language query 106 to identify an executable target function 108T of a software program 120 (e.g., associated with a respective user application 122)).

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, memory 556, optionally, stores a subset of the modules and data structures identified above. Furthermore, memory 556, optionally, stores additional modules and data structures not described above.

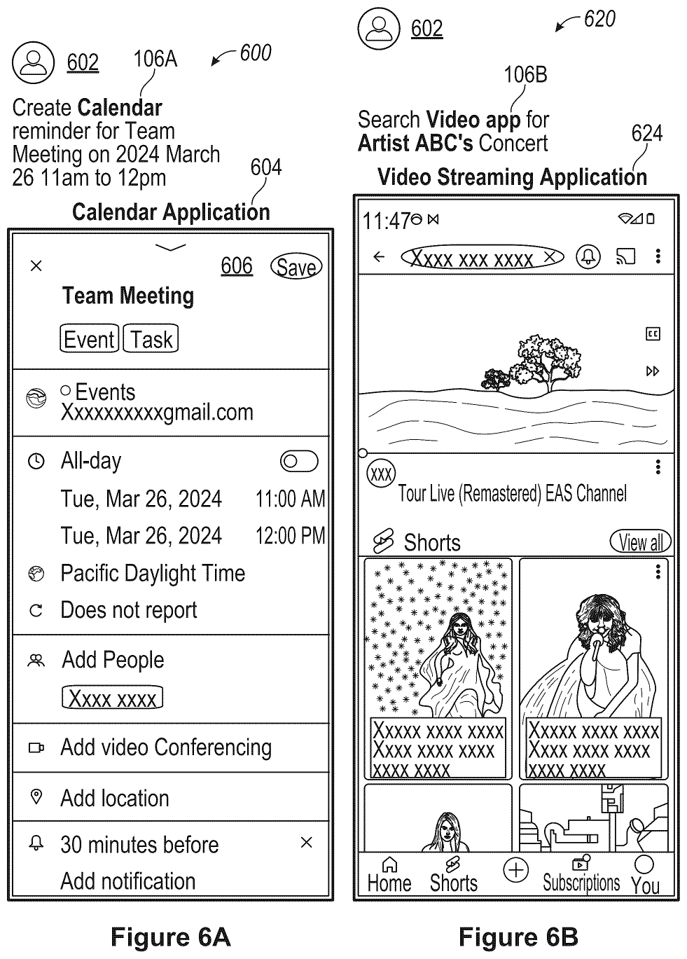

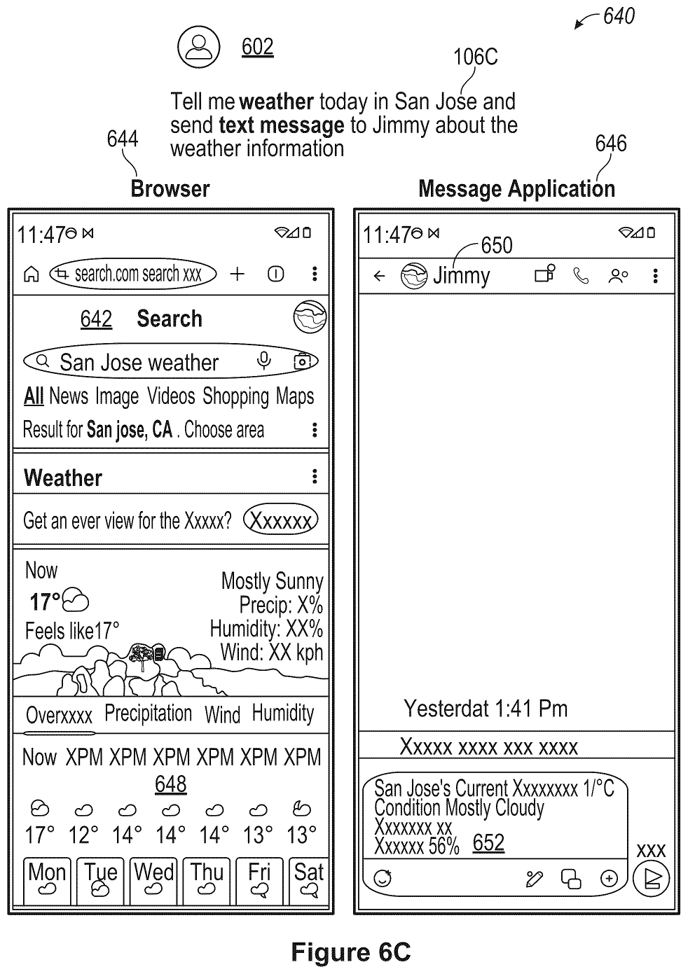

FIGS. 6A-6C illustrate three example automated workflows 600, 620, and 640 of calling functions 108 based on natural language queries 106 in a client device 104, in accordance with some embodiments. The client device 104 (e.g., a mobile phone 104D in FIG. 1) receives a natural language query 106. In response to the natural language query 106, the client device 104 provides the natural language query 106 as an input to a function determination model for generating function information 536 associated with a target function 108T, and obtains the function information 536 of the target function 108T. The function information 536 further includes identification information (e.g., a function name) and one or more parameters 540 (also called arguments) of the target function 108T. The target function 108T is implemented based on the function information 536. In some embodiments, the natural language query 106 is entered on a user interface 125 rendered in a second program 120B, and the target function 108T is associated with a first program 120A that is identical to or distinct from the second program 120B. For example, the natural language query 106 is entered via a user interface 125 rendered by an operating system of the client device 104, so is the target function 108T part of the operation system. In another example, the natural language query 106 is entered via the operating system of the client device 104, and the target function 108T is implemented by a user application 122A distinct from the operating system of the client device 104. In some embodiments, the natural language query 106 is entered via a user application 122B, and the target function 108T is implemented by the same user application 122B, a distinct user application 122A, or the operating system of the client device 104.

Referring to FIG. 6A, in some embodiments, the client device 104 receives a user input of a natural language query 106A (e.g., “Create calendar reminder for Team Meeting on 2024 Mar. 26 11 am to 12 pm”) via an operating system (OS) prompt interface 602 of the client device 104. A target function 108T is associated with a calendar application (e.g., Google Calendar), and identified by a language model 112 (e.g., a function determination model) in response to the natural language query 106A. The target function 108T is automatically implemented by the calendar application 604, e.g., via an API of the client device 104 receiving the query 106A, and a calendar object 606 is created in the calendar application 604. The calendar object 606 includes one or more data items including one or more of: event description, meeting date, start time, end time, time zone, repeatability, meeting location, virtual link, reminder rule, and attendee. The one or more data items of the calendar object 606 match parameters 540 of the target function 108T that are generated by the function determination model and provided to the calendar application 604 in the function information 536 of the target function 108T, thereby allowing the calendar object 606 to be created, identified, and loaded based on the query 106A.

Referring to FIG. 6B, in some embodiments, the client device 104 receives a user input of a natural language query 106B (e.g., “Search Videoapp for Artist ABC's concert”). A target function 108T is associated with a video streaming application 624 (e.g., YouTube), and identified by a language model 112 (e.g., a function determination model) in response to the natural language query 106B. For example, the target function 108T is search_videoapp_videos (query, max_results=10, search_filter=“Relevance”). The target function 108T is automatically implemented by the video streaming application 624, e.g., via an API of the client device, to automatically identify and load a page including a plurality of clip thumbnails associated with Artist ABC's concerts in the video streaming application 624. Information of the clip thumbnails matches one or more parameters 540 of the target function 108T that are generated by the function determination model and provided to the video streaming application 624 in the function information 536 of the target function 108T, thereby allowing the clip thumbnails associated with Artist ABC's concert to be identified and loaded in response to the query 106B.

Referring to FIG. 6C, in some embodiments, the client device 104 receives user input of a natural language query 106C (e.g., “Tell me weather today in San Jose and send text message to Jimmy about the weather information”). Two parallel target functions 108T are identified by a language model 112 (e.g., a function determination model) in response to the natural language query 106B. The parallel target functions 108T are associated with a public search engine 642 loaded via a browser 644 and a message application 646 installed on the client device 104. In an example, the target functions 108 includes get_weather_forecast (location, days) and send_message (recipient, subject, body, attachments=None, cc=None, bcc=None). The target functions 108T are automatically implemented by a public search engine 642 and the message application 646, respectively. A set of first parameters 540 (e.g., “weather,” “today,” and “San Jose”) of the target functions 108T are applied by the public search engine 642 to identify an online weather information source, determine date and location, and extract requested weather information 648. A set of second parameters 540 (e.g., “Jimmy,” and “weather information”) of the target functions 108T are applied by the message application 646 to identify a message receiver 650 and message content 652 sent to the message receiver 652. Stated another way, in some embodiments, the natural language query 106 is used to initiate a plurality of parallel functions. Each of the plurality of parallel functions is implemented by a respective distinct user application identified by respective identification information and based on a subset of respective one or more parameters 540 of the respective parallel function.

FIG. 7A is a flow diagram of an example function prediction process 700 implemented based on retrieval of function information 536, in accordance with some embodiments, and FIG. 7B is a flow diagram of another example function prediction process 750 implemented based on functional tokens, in accordance with some embodiments. One or more user applications 122 may be executed at a computer system 100 including a client device 104, one or more application servers 102A, or a combination thereof. The user application(s) 122 are configured to implement a plurality of predefined functions 108 including a target function 108T. The client device 104 receives a natural language query 106. In response to the natural language query 106, the computer system 100 applies a language model 112A or 112B to generate function information 536 of the target function 108T based on the natural language query 106, and the function information 536 of the target function 108T includes identification information 538 and one or more parameters 540 of the target function 108T. The target function 108T is implemented based on the function information 536.

In some embodiments, the function prediction process 700 includes a function selection stage and a parameter generation stage. During the function selection stage, description of each predefined function 108 and associated function parameters 540 (also called arguments) is interpreted based on information associated with the natural language query 106 to create parameters 540 for the respective predefined function 108. In some embodiments, a classification model is combined with the language model 112A. The plurality of predefined functions 108 form a selection pool of available functions, transforming a function selection challenge into softmax classification. In some embodiments, the classification model is applied to implement retrieval-based document selection, identifying the target function 108 that most closely matches the natural language query 106 by semantic similarity. Alternatively, in some embodiments, the classification model is applied to map the natural language query 106 to a specific function name. Alternatively, a Generative Pre-trained Transformer (GPT) model (e.g., a language model 300 in FIG. 3) is applied to predict the function name from the natural language query 106 within the context of the plurality of predefined functions 108. A function prediction process 700 is represented as follows:

$$P ( f \vert q ) = P ( f \vert q ; {π}_{1} ) , P ( params \vert f , q ) = P ( params \vert f , q ; {π}_{2} ) . \qquad ( 1 )$$

where π₁ and π₂ represents two models, q denotes the query 106, f signifies identification information of the target function 108T, and params represent the parameters 540 of the target function 108T. The function prediction process 700 involves retrieving relevant functions and providing context about several pertinent functions to deduce the optimal function names. In most use cases, the set of possible function names is fixed. When utilizing a language model to formulate a function name, multiple tokens must be generated to form one function name, which can lead to inaccuracies.

Referring to FIG. 7A, in some embodiments, the language model 112A is applied to select a target function 108T from a plurality of predefined functions 108 and determine function parameters 540 used by the target function 108T. The natural language query 106 is vectorized (operation 702) and applied in a semantic search 704 of a pool of available functions (e.g., the plurality of predefined functions 108). A subset of the plurality of predefined functions 108 is identified from the semantic search 704, and corresponding function description is converted to a set of semantic tokens 706. The set of semantic tokens 706 and the natural language query 106 are combined to generate a full prompt 708, and inputted to the language model 112A to generate the function information 536 of the target function 108T. Generation of the semantic tokens 706 increases a complexity level of the full prompt 708 to be processed by the language model 112A, compared with the query 106.

Referring to FIG. 7B, in some embodiments, a uniformed language model 112B (e.g., a function determination model 740) is applied based on multitask learning/meta learning to enhance inference speeds and system convenience. The language model 112B is also called a GPT model and established based a transformer architecture. A function prediction process 750 is represented as follows:

$$P ( f , params \vert q ) = P ( f \vert q ; π ) P ( params \vert f , q ; π ) . \qquad ( 2 )$$

The function prediction process 750 designates the plurality of predefined functions as unique functional tokens 720. For example, token names range from <nexa_0> to <nexa_N−1> to symbolize the plurality of predefined functions 108 in the pool of available functions. This transforms the prediction task for function names into a single-token classification among the N functional tokens 720, enhancing the accuracy of function name prediction, while reducing the number of tokens required. Special functional tokens (e.g., <nexa_0> to <nexa_N−1>) are introduced into a tokenizer and modify an architecture of a pretrained model to expand the language head by an additional N units. For function name prediction, the language model 112B is used to pinpoint the correct function among the N functional tokens 720 through argmax probability selection. The language model 112B grasps the meaning associated with that functional token. In some embodiments, function descriptions is incorporated into a training dataset, enabling the language model 112B to learn the importance of these specialized functional tokens 720. In some embodiments, a prompt template is applied to accommodate a plurality of response styles, facilitating parallel and nested function calls.

In some embodiments, the language model 112B is fine-tuned to understand a significance of functional tokens 720, and further applied for data inference by employing the added functional tokens 720, <nexa_end>, as the early stopping criterion. This strategy negates the necessity to analyze tokens from function descriptions, removing the retrieval of relevant functions and the processing of their descriptions. Consequently, this considerably diminishes the number of tokens needed to accurately identify a function name.

More specifically, in some embodiments, a query 106 is received from a user 110 and used to select a target function 108T from a plurality of predefined functions 108 and generate functional parameters 540 used to call the target function 108T. An example data structure of the query 106 and a response associated with the target function 108 is represented as follows:

Query: {query}
# for single function call
Response: <nexa_i> (paraml, param2, ... )<nexa_end>
# for parallel function call
Response:<nexa_i> (paraml, param2, ... ) ; <nexa_j> (paraml, param2, ... )<nexa_end>
# for nested function call
Response:<nexa_i> (paraml, <nexa_j> (paraml, param2, ... ), ... )<nexa_end>
Function description: {function_description}

In an example, the target function 108 is a nested function including a first function (e.g., <next_i>) and a second function (e.g., <nexa_j>) nested in the first function. When the target function 108 is called, the second function (e.g., <next_j>) is implemented to generate an intermediate parameter, and the first function (e.g., <next_i>) is implemented using the intermediate parameter.

In some embodiments, a user application 122 includes a plurality of predefined functions 108 including a target function 108T. Each predefined function 108 corresponds to a functional token 720. The language model 112B is trained to recognize a plurality of functional tokens 720 corresponding to the plurality of predefined functions 108. In some embodiments, training techniques analogous to those used in natural language models for handling rare words may be applied to train the language model 112B. An example training technique is based on a Word2vec framework, which uses vector representations of words to capture information of a particular word based on surrounding words. For instance, pretrained language models may initially struggle to recognize specialized terms such as PEGylation and Endosomal Escape from the domain of chemistry. The language models 112B can learn such terms through causal language modeling, leveraging corpora that include these specialized terms. In some embodiments, functional tokens 720 can be learned by the language models 112B via training. Examples of the functional tokens 720 associated with a mobile phone 104D include, but are not limited to, take_a_photo, get_trending_news, get_weather_forecast, send_email, and search_youtube_videos, and correspond Android functions are listed as follows:

```
def take_a_photo(camera=“back”, resolution=“1080p”):
  “““
  Captures a photo using the specified camera and resolution settings.
  Parameters:
  - camera (str, optional): Specifies the camera to use. Can be ‘front’ or ‘back’.
  The default is ‘back’. Optional to provide.
  - resolution (str, optional): Sets the photo resolution. Options include ‘720p’,
  ‘1080p’, and ‘4K’. The default is ‘1080p’. Optional to provide.
  Returns:
  - str: The string contains the file path of the captured photo if successful, or an
  error message if not. Example: ‘/storage/emulated/0/Pictures/MyApp/IMG_{—}
  20240310_123456.jpg’
  ”””
def get_trending_news(category=None, region=‘US’, language=‘en’, max_results=5):
  “““
  Fetches trending news articles based on category, region, and language.
  Parameters:
  - category (str, optional): News category to filter by, by default use None for
  all categories. Optional to provide.
  - region (str, optional): ISO 3166-1 alpha-2 country code for region specific
  news, by default, uses ‘US’. Optional to provide.
  - language (str, optional): ISO 639-1 language code for article language, by
  default uses ‘en’. Optional to provide.
  - max_results (int, optional): Maximum number of articles to return, by
  default, uses 5. Optional to provide.
  Returns:
  - list[str]: A list of strings, each representing an article. Each string contains
  the article's heading and URL.
  ”””
def get_weather_forecast(location, days=1):
  “““
  Provides a weather forecast for a specified location over a given number of
  days. Each day's forecast includes a brief description of the expected weather
  conditions.
  Parameters:
  - location (str): The location for which the weather forecast is desired. Can be
  a city name, ZIP code, or other location identifiers.
  - days (int, optional): The number of days to include in the forecast, starting
  from today. The default is 1 day. Optional to provide.
  Returns:
  - list[str]: A list of strings, each representing the weather forecast for one day.
  Each string includes the date and a brief description of the weather conditions.
  Formatted in ‘YYYY-MM-DD: Description’ format.
  ”””
def send_email(recipient, subject, body, attachments=None, cc=None, bcc=
None):
  “““
  Sends an email with optional attachments, CC, and BCC.
  Parameters:
  - recipient (str): Primary recipient's email address.
  - subject (str): Email subject line.
  - body (str): Main email body content.
  - attachments (list of str, optional): A list of file paths representing files to
  attach to the email. Defaults to None, indicating no attachments. Optional to
  provide.
  - cc (list of str, optional): A list of email addresses to include in the Carbon
  Copy (CC) field. Defaults to None. Optional to provide.
  - bcc (list of str, optional): A list of email addresses to include in the Blind
  Carbon Copy (BCC) field. Defaults to None. Optional to provide.
  Returns:
  ”””
def search_youtube_videos(query, max_results=10, search_filter=“Relevance”):
  “““
  Searches YouTube for videos matching a query.
  Parameters:
  - query (str): Search query.
  - max_results (int, optional): Maximum number of search results, by default,
  use 10. Optional to provide.
  - search_filter (enum, optional): Filter for search results, chosen from
  ‘Relevance’, ‘Upload date’, ‘View Count’, ‘Rating’. By default, use
  ‘Relevance’. Optional to provide.
  Returns:
  - list[str]: A list of strings, each string includes video names and URLs.
  ”””
```

Examples of the functional tokens 720 associated with a client device 104 corresponding to a vehicle include, but are not limited to, adjust_volume, set_climate_temperature, adjust_seat_position, control_window, and operate_sunroof, and correspond Android functions are listed as follows:

```
def adjust_volume(volume_diff=None, set_value=None):
  “““
  Adjusts the device's volume by a specified difference or sets it to a specified
  value. Only one operation can be performed at a time.
  Parameters:
  - volume_diff (int, optional): The amount to adjust the current volume by.
  Positive to increase, negative to decrease, optional to provide.
  - set_value (int, optional): The target volume level to set, in the range of 0 to
  50, optional to provide.
  Note:
  - If both ‘volume_diff’ and ‘set_value’ are provided, only one will be
  considered based on the implementation's logic.
  Returns:
  - bool: True if the volume was adjusted successfully, False otherwise.
  ”””
def set_climate_temperature(zone, temperature):
  “““
  Configures the temperature for a specific zone within the vehicle's climate
  control system.
  Parameters:
  - zone (str): The zone to set the temperature for (’driver’, ‘passenger’, ‘rear’).
  - temperature (int): The target temperature in Fahrenheit, within the range of
  60 to 80 degrees.
  Returns:
  - bool: True if the temperature was set successfully, False otherwise.
  ”””
def adjust_seat_position(seat, position, distance):
  “““
  Modifies the position of a specified seat by a certain distance.
  Parameters:
  - seat (str): The seat identifier (’driver’, ‘passenger’).
  - position (str): The direction to adjust the seat in (’forward’, ‘backward’, ‘up’,
  ‘down’).
  - distance (int): The amount of adjustment in millimeters.
  Returns:
  - bool: True if the seat was adjusted successfully, False otherwise.
  ”””
def control_window(window, position, distance):
  “““
  Adjusts a vehicle window's position by a specific distance.
  Parameters:
  - window (str): The window to control (’front left’, ‘front right’, ‘rear left’,
  ‘rear right’).
  - position (str): The direction to move the window (’up’ or ‘down’).
  - distance (int): The distance to move the window, in millimeters.
  Returns:
  - bool: True if the window was adjusted successfully, False otherwise.
  ”””
def operate_sunroof(action, intensity=None):
  “““
  Operates the sunroof with a specified action and optional intensity.
  Parameters:
  - action (str): The sunroof operation to perform (’open’, ‘close’, ‘tilt’).
  - intensity (int, optional): The degree to which the sunroof should be opened or
  tilted, as a percentage, optional to provide.
  Returns:
  - bool: True if the sunroof was operated successfully, False otherwise.
  ”””
```

Referring to FIGS. 7A and 7B, the language model 112B is trained to classify the natural language query 106 to a functional token 720, while the language model 112A is trained to analyze semantic features (also called linguistic or semantic tokens) of the natural language query 106 and associated function description to generate a corresponding function 108 semantically. Compared with the language model 112A, the language model 112B simplifies identification of the target function 108T is simplified, enhances an accuracy level of identifying the target function 108T and associated functional parameters 540, and reduces a latency of identifying and calling the target function 108.

In some embodiments, as usage of the functional tokens 720 allows the language model 112B to be simplified, smaller-scale language models (e.g., Google Gemma 2B) are applicable to identify the target function 108T from a plurality of predefined functions 108. In some embodiments, functional tokens 720 do not possess inherent natural language meaning, and represents specific functions, instructions, or actions encapsulated within the language model 112B. The language model 112B is characterized as a small action model for identifying a functional token 720 representing a target function 108T including respective actions. Integration of the functional tokens 720 enables the plurality of predefined functions 108 (e.g., corresponding to a fixed set of actions) to be recognized by the language model 112B and performed automatically and efficiently. In some embodiments, functional tokens 720 are applied jointly with linguistic tokens of the natural language query 106 and/or function description of one or more predefined functions 108 (e.g., the target function 108T).

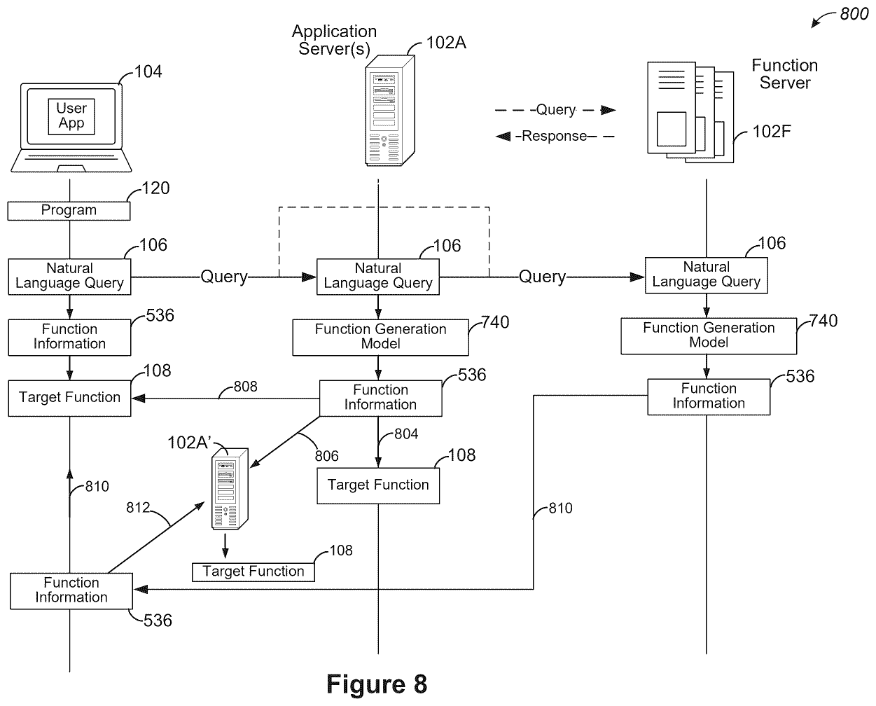

FIG. 8 is a flow diagram of an example function calling process 800 implemented by a computer system 100, in accordance with some embodiments. The computer system 100 includes a client device 104, an application server 102A, and a function server 102F. The client device 104 executes a program 120 (e.g., a second program 120B) to receive a natural language query 106. In some embodiments, an operation session is started to receive the natural language query 106. The natural language query 106 is applied to generate the function information 536 associated with a target function 108T without receiving any context information with the natural language query 106. In some situations, the target function 108T is selected from a plurality of predefined functions 108 associated with one or more user applications 122 executed by the computer system 100, and no user input is entered with the query 106 to provide information associated with the plurality of predefined functions 108. In some embodiments, function information 536 of the target function 108T is generated based on the natural language query 106 only, independently of any other query distinct from the natural language query 106.

In some embodiments, the client device 104 applies a function determination model 740 (e.g., a language model 112B) locally to generate the function information 536 associated with the target function 108T. The function determination model 740 may be trained at a function server 102F and provided to the client device 104.

In some embodiments, the client device 104 sends the natural language query 106 to an application server 102A associated with the program 120. The application server 102A applies a function determination model 740 to process the natural language query 106 and generates function information 536 of the target function 108 including identification information 538 (e.g., function name) and one or more parameters 540 of the target function 108. In some embodiments, the target function 108 continues to be executed (operation 804) by the same application server 102A based on the function information 536 of the target function 108. More specifically, the target function 108 continues to be executed by the program 120 at the application server 102A. Alternatively, in some embodiments, the target function 108 corresponds to a user application 122 associated with a distinct application server 102A′, which obtains (operation 806) the function information 536 of the target function 108 and executes the target function 108 based on the function information 536. Alternatively, in some embodiments, the function information 536 of the target function 108 generated by the application server 102A is returned (operation 808) to the client device 104, and the target function 108 is implemented by the client device 104, independently of whether the target function 108 is associated with the program 120 or a distinct program or user application.

In some embodiments, after obtaining the query 106, the client device 104 sends the query 106 to a function server 102F, which trains the function determination model 740. The function server 102F applies the function determination model 740 to process the natural language query 106 and generates function information 536 of the target function 108 including identification information 538 (e.g., function name) and one or more parameters 540 of the target function 108. The function information 536 of the target function 108T is returned (operation 810) to the client device 104. In some embodiments, the client device 104 implements the target function 108T based on the function information 536. Alternatively, in some embodiments, the client device 104 identifies an application server 102A corresponding to a user application 122 configured to implement the target function 108T, and sends (operation 812) the function information 536 to the application server 102A′, which implements the target function 108T based on the function information 536.

In some embodiments, the program 120 that receives the natural language query 106 is distinct from the user application 122 that implements the target function 108T. The program 120 is configured to communicate with the user application 122 via an API. The client device 104 or the application server 102A associated with the program 120 applies the API of the user application 122 to implement the target function 108T at the application server 102A′ associated with the user application 122.

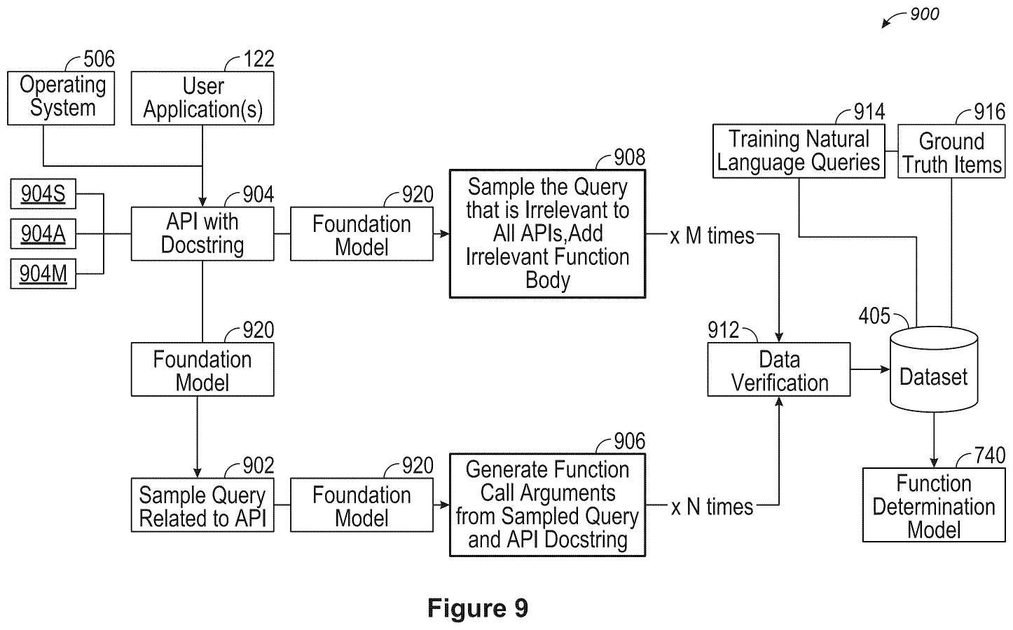

FIG. 9 is a flow diagram of an example training data collection process 900 implemented based on a foundation model 920, in accordance with some embodiments. This process 900 is applied to generate training datasets 405 of superior quality for the phases of training, validation, and testing of a function determination model 740 (e.g., which includes a language model). The process 900 includes creation of sample queries 902 (e.g., a natural language query 106) related to APIs 904 and generation of function calls 906 and creation 908 of queries that are irrelevant to the APIs 904, complemented by unrelated function bodies. Incorporating a binary validation mechanism ensures the collection of an optimized training dataset 405, poised to significantly improve model functionality. In some embodiments, the training datasets 405 correspond to a corpus of training data, and include a plurality of training natural language queries 914 and a plurality of ground truth items 916. Each training natural language query 914 corresponds to a respective ground truth item 916, and each ground truth item 916 is associated with a respective one of the plurality of predefined functions 108 associated with one or more associated user applications 122. Further, in some embodiments, the function determination model 740 is trained at the function server 102F using the training datasets 405.

In some embodiments, the APIs 904 are implemented in an operating system (e.g., Android, IOS, HarmonyOS, Microsoft Windows, macOS, Linux, Chrome OS, FreeBSD). In some situations, one or more APIs 904 are applied in an operating system executed on a vehicle. In some embodiments, the APIs 904 includes one or more of: a system API 904S, a user application API 904A, and a smart device management API 904M on the operating system. The system API 904 is applied to perform system-level functions essential for basic mobile operations of the operating system, such as making calls, texting, setting alarms, modifying screen brightness, creating calendar entries, managing Bluetooth, enabling do-not-disturb mode, and taking photos. In some embodiments, the system API 904 is not prohibited from performing highly sensitive tasks like accessing system state information or changing accessibility settings. Further, the user application APIs 904A are associated with user applications 122 installed on the operating system. Example of the user applications 122 include, but are not limited, pre-installed Google applications on Android devices, such as YouTube, Google Chrome, Gmail, and Google Maps. The user application APIs 904A provide functionalities including accessing trending news, retrieving weather updates, searching for YouTube content, and map navigation. In some implementations, Google Home ecosystem includes a wide range of smart home devices (e.g., surveillance cameras). In some embodiments, the smart device management APIs 904M are applied to manage smart home devices, covering functions like adjusting a thermostat, managing media playback on a display interface device, and controlling door locks using the user applications 122 associated with the smart home devices.

In some embodiments, the training datasets 405 are created using a foundation model 920 (e.g., Google Gemini) by generating relevant queries 902 and their associated function call arguments (operation 906), developing irrelevant queries accompanied by irrelevant function bodies (operation 908), and implementing binary verification support (operation 912). In some situations, the foundation model 920 is applied to generate relevant queries and function calls, creating a high-quality training dataset 405. The relevant queries correspond to positive queries that a single API can resolve. Based on a query and predetermined API descriptions in hand, a subsequent API call is applied in the foundation model 920 to produce the required function call arguments. In some embodiments, examples from both positive and negative datasets are applied. Irrelevant queries and irrelevant function bodies are used as negative samples to enhance analytical skills of the function determination model 740. An equilibrium between the irrelevant queries and the relevant queries is represented by a ratio of two integers M and N. In an example, the integer numbers M and N are equal, each assigned a value of 1000.

In some embodiments, the foundation model 920 has a noticeable rate of errors, particularly in generation of function call arguments. These errors may manifest as missing arguments, incorrect argument types, or misinterpretations of the intended query. The process 900 allows the foundation model 920 to evaluate the completeness and accuracy of its generated function calls. In some situations, a relevant or irrelevant query or associated parameters or arguments are found missing during data verification 912, and a regeneration process is applied to generate the relevant or irrelevant query.

In some embodiments, full model training is applied to train the function determination model 740. For instance, an adaptive moment estimation (Adam) optimizer with weight decay (also called an AdamW optimizer) is applied to decouple weight decay regularization from gradient-based optimization. The AdamW optimizer has a learning rate set at 5×10⁻⁵, a warm-up step of 10, a number of epochs equal to 3, and a linear learning rate scheduler.

Alternatively, in some embodiments, low-rank adaptation (LoRA) is applied to train the function determination model 740. Optimizer and learning rate configurations of a corresponding AdamW optimizer are applied to LoRA-based training. For example, a LoRA rank is set to 16, and LoRA is applied to a plurality of modules including q_proj, k_proj, v proj, o_proj, up_proj, down_proj. An LoRA alpha parameter is set to 32. A number of epoch is set to 3 for LoRA-based training. In some embodiments, LoRA is applied to integrate the function determination model 740 across multiple user applications 122 to ensure smooth computation. Instead of employing full models for each API set, LoRA training is customized according to specific function setups of different applications 122. For example, each respective user application 122 corresponds to one or more respective functions 108, and a loss function includes one or more function terms corresponding to the one or more respective functions 108 in addition to normal loss terms that are independent of the one or more respective functions 108. For LoRA-based training, the one or more function terms may be assigned with weights greater than those of the normal loss terms with no or litter impact on an accuracy level of an output of the function determination model 740. The accuracy levels are of the function determination model 740 that is trained using LoRA are sufficiently robust for production deployment. For LoRA, after the function determination model 740 is trained using the training datasets 405, the computer system 100 freezes model weights of the function determination model 740, and injects trainable rank decomposition matrices into each layer of the function determination model 740.

Stated another way, in some embodiments, when the function determination model 740 is trained, the computer system 100 generates a loss function based on a weighted combination of a plurality of loss terms. The plurality of loss terms include a functional token term corresponding to the predefined functions 108 and one or more alternative terms distinct from the functional token term and not associated with the predefined functions 108. The functional token term indicates an accuracy level of the identification information 536 of the respective target function 108T generated for each training natural language query 914. A weight of the function toke term is greater than any other weight of a remainder of the plurality of loss terms.

In some embodiments, in response to a query 106, a function 108 is generated and includes a single function, a set of parallel functions, or a nested function. For a particular API 904, the training dataset 405 includes a first subset of training data 405A corresponding to one or more single functions, a second subset of training data 405B corresponding to one or more sets of parallel functions, and a third subset of training data 405C corresponding to one or more nested functions. In some embodiments, 4K data points are created for the particular API 904 for generating outputs corresponding to the parallel functions and the nested functions with an accuracy level comparable to that of the outputs of the single functions.

In some embodiments, functional tokens 720 are incorporated into a function determination model 740 (e.g., a language model 112B), expanding the model's head. A loss function L of the function determination model 740 is defined as follows:

$$ℒ = - {\sum }_{t = 1}^{T} {\sum }_{i}^{V} {y}_{t , i} log ( {\hat{y}}_{t , i} ) , \qquad ( 3 )$$

where T represents a sequence length of a natural language query 106, and V denotes a vocabulary size. In an example, a target function 108T is selected from a plurality of predefined functions 108 corresponding to a plurality of functional tokens 720 ranging from <nexa_0> to <nexa_N−1>, along with a distinct token <nexa_end>, which are absent in a pretrained dataset (e.g., Gemma-2B dataset). The loss function L includes a weighted cross-entropy loss configured to improve convergence as follows:

$$ℒ = - {\sum }_{t = 1}^{T} {\sum }_{i}^{V} {ω}_{i} {y}_{t , i} log ( {\hat{y}}_{t , i} ) , \qquad ( 4 )$$

In an example associated with the above configuration, tokens distinct from functional tokens 720 are assigned a weight of 1, while the functional tokens 720 associated with the predefined functions have weight values greater than 1 to expedite convergence. The validation loss, based on Equation (3) with varying weighted entropy losses for training, suggests that employing a weighted entropy loss early in the training process aids convergence. No or little performance disparity is observed in the fine-tuned model, and no significant differences are seen in a wall-clock time. In some embodiments, an equal-weighted token loss is used for a subset of the functional tokens 720 associated with the plurality of predefined functions 108. In some embodiments, the plurality of weights assigned to the plurality of functional tokens 720 are equal to one another.

In some implementations, the computer system 100 obtains a base language model (e.g., the foundation model 920) configured to process natural language queries 106, and trains the base language model using a corpus of training data 405 to generate a function determination model 740 applied to determine a target function 108T (e.g., select the target function 108T from a plurality of predefined functions 108). Application of the base language model helps expedite training for the purposes of function calling.

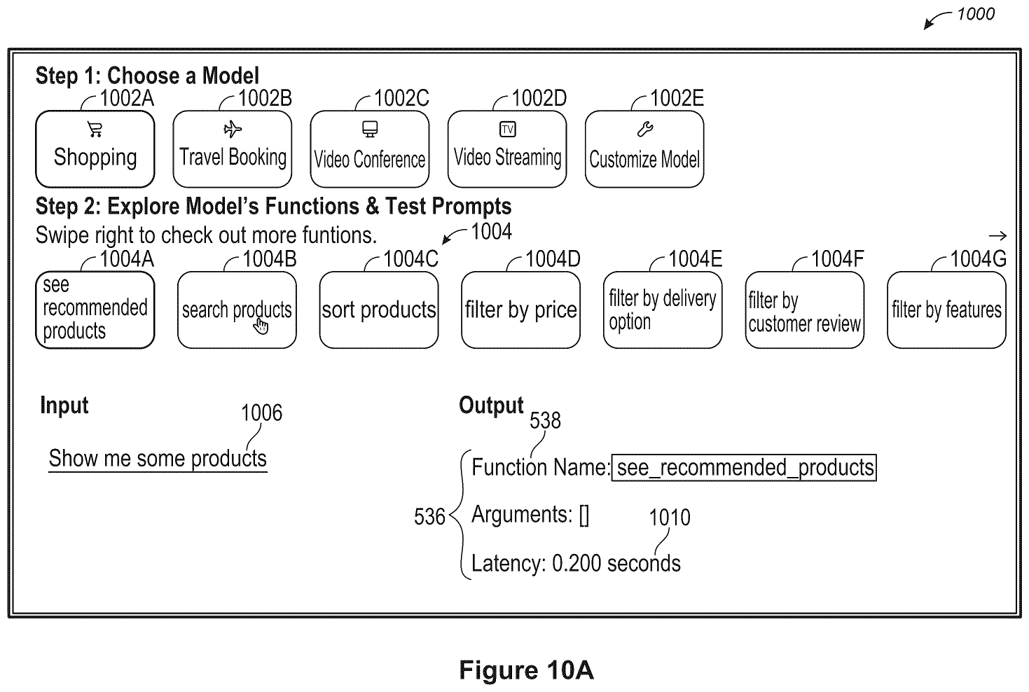

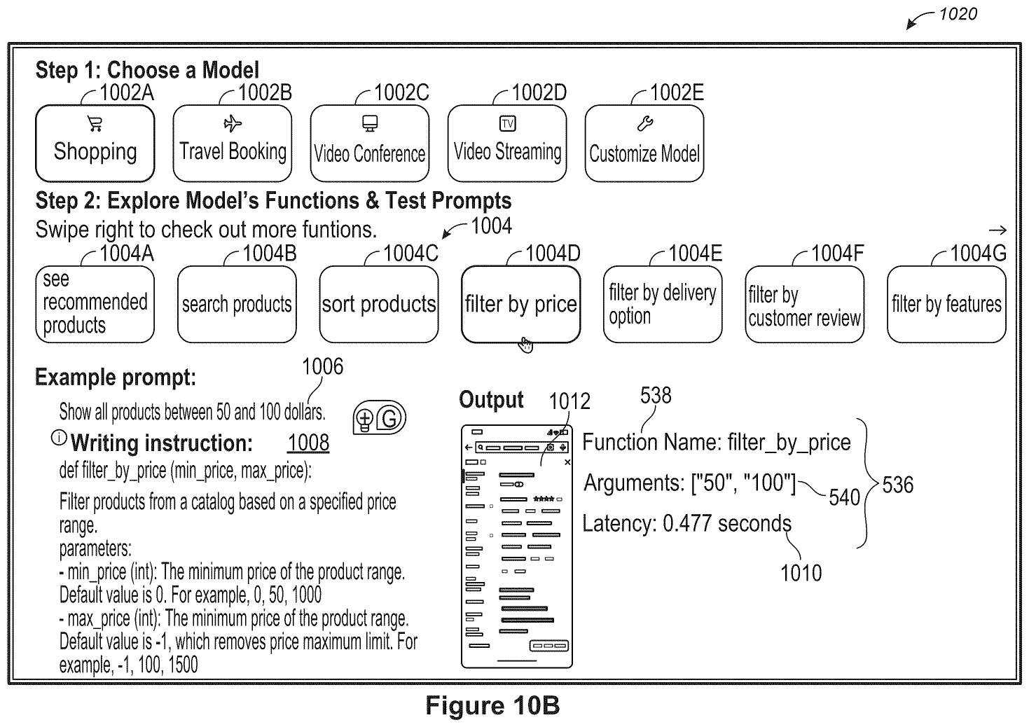

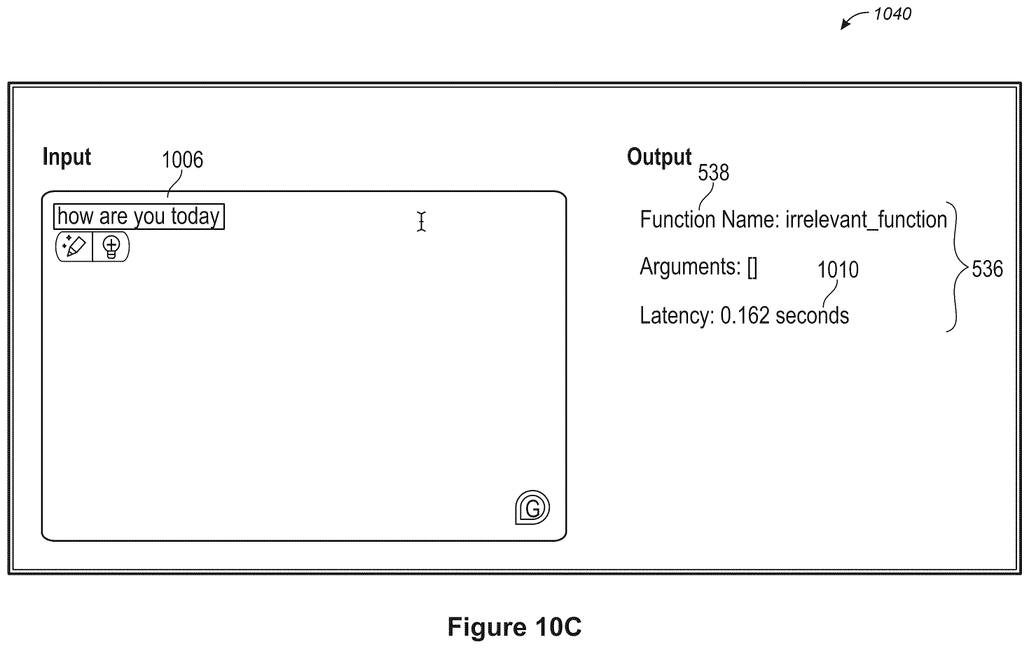

FIGS. 10A-10C are three example user interfaces 1000, 1020, and 1040 showing functional tokens 720 (e.g., see_recommended_products, filter_by_price, irrelevant_function), in accordance with some embodiments. In some embodiments, a computer system 100 executes a program 120 configured to render the user interfaces 1000, 1020, and 1040. A natural language query 106 is received on the user interface 1000, 1020, or 1040. In response to the natural language query 106, the computer system 100 applies a function determination model 740 (e.g., a language model 112) to generate function information 536 associated with the target function 108 based on the natural language query 106. The function information 536 further includes identification information 538 (e.g., function name). In some embodiments, the function information 536 further includes one or more parameters 540 (also called arguments) of the target function 108T. The target function 108 is implemented based on the function information 536. In some embodiments, the target function 108T is implemented in the program 120. Alternatively, in some embodiments, the target function 108T is implemented in an alternative program (e.g., first program 120A in FIG. 1) distinct from the program 120 (e.g., second program 120B in FIG. 1) obtaining the natural language query 106.

Referring to FIGS. 10A and 10B, the program 120 provides a plurality of language models 112 represented by a plurality of model affordances 1002A-1002E. Each of the plurality of model affordances 1002A-1002E is labelled with “Shopping,” “Travel Booking,” “Video Conference,” “Video streaming,” or “Customize Model,” and represents a shopping function model, a travel-booking function model, a video conference function model, a video streaming function model, or a supplemental function determination model. A first user input is received via the model affordances 1002A-1002E to select one of the plurality of language models 112. Each of the model affordances 1002A-1002E corresponds to a set of respective programs 120 and their associated predefined functions 108. For each of the model affordances 1002A-1002D, the set of respective programs is associated with “Shopping,” “Travel Booking,” “Video Conference,” or “Video streaming,” respectively. For the model affordance 1002E representing the supplemental function determination model, the set of respective programs 120 correspond to a set of user-selected programs 120 and associated predefined functions 108. In some embodiments, in response to a user selection of the model affordance 1002A, the shopping function model is selected as the function determination model 740 to select the target function 108T from a plurality of predefined functions 108 associated with a set of respective shopping applications.

In some embodiments, the natural language query 106 is entered on the user interface 1000 or 1020 via a user input (e.g., a prompt 1006 including a sequence of one or more words). In some embodiments, the natural language query 106 is entered on the user interface 1000 or 1020 via a plurality of user inputs. The plurality of user inputs include a selection of a plurality of function affordances 1004 (e.g., affordances 1004A, 1004B, 1004C, 1004D, 1004E, 1004F, and 1004G). For example, each of the plurality of function affordances 1004A-1004G is labeled “see recommended product,” “search products,” “sort products,” “filter by price,” “filter by delivery option,” “filter by customer review,” or “filter by features,” and represents a respective subset of the predefined functions 108 associated with the set of respective programs 120 corresponding to the selected model affordance (e.g., affordance 1002A). In some embodiments, the plurality of user inputs further include a prompt 1006 including a sequence of one or more words. Referring to FIG. 10A, in some embodiments, the user inputs include a selection of the function affordance 1004A (e.g., associated with “see recommended products”) and a prompt 1006 of “Show me some products.”

In some embodiments, in response to a user selection of one of the function affordances 1004A-1004G, description of a target function 108T corresponding to the selected function affordance is displayed is a writing instruction panel 1008. For example, referring to FIG. 10B, in response to a user selection of the function affordance 1004D, the target function 108T is identified as filter_by_price, and associated function description is displayed on the writing instruction panel 1008 of the user interface 1020. The associated description displayed on the writing instruction panel 1008 provides guidance on the user input of the prompt 1006. For example, a user is prompted to enter information of one or more parameters 540, e.g., “min_price” and “max_price” as entered in the prompt 1006 of “Show all products between 50 and 100 dollars.” More examples of the function description are explained above with reference to FIGS. 7A and 7B.

In some embodiments, the identification information 538 of the target function 108T includes a function name (e.g., “see_recommended_products”), or more specifically, a syntax element corresponding to the function name of the target function 108T. Alternatively, in some embodiments, the identification information 538 of the target function 108T includes an index number identifying one of a plurality of syntax elements corresponding to a plurality of function names of the plurality of predefined functions 108. For example, the identification information 538 is “3” identifying “see_recommended_products” among the function names of the plurality of predefined functions 108 corresponding to the selected model affordance. In some embodiments, the function information 536 (e.g., the function name) of the target function 108T generated by the function determination model 740 is displayed on the user interface of the program 120.

Referring to FIG. 10A, in some embodiments, the target function 108T does not include any parameter. Referring to FIG. 10B, in some embodiments, the function information 536 further includes one or more parameters 540 (also called arguments) of the target function 108T. The natural language query 106 entered by the user includes the one or more parameters 540 (e.g., “50” and “100” entered in the prompt 1006 of “Show all products between 50 and 100 dollars.”). In some embodiments, the function information 536 further includes a latency 1010 associated with the target function 108T, and the latency 1010 is displayed jointly with the function information 536. Further, in some embodiments, the target function 108T is associated with a shopping user application, and a preview 1012 of the shopping user application is displayed to show that the target function 108T may be implemented with the parameters 540.

Referring to FIG. 10C, in some embodiments, the natural language query 106 (e.g., “how are you today”) does not correspond to any function executed by the target function 108T. The function determination model 740 corresponding to the selected model affordance generates function information 536 including identification information 538 (e.g., “irrelevant_function”) without any arguments 540. Stated another way, in some embodiments, the plurality of predefined functions 108 is expanded to include an irrelevant query alert function (e.g., having a function name of “irrelevant_function”) and a remainder of plurality of predefined functions 108 that is associated with one or more associated user applications 122. When the target function 108T is implemented, the computer system 100 determines that the identification information 536 corresponds to the irrelevant query alert function, and generates an alert message on a user interface, indicating that the natural language query 106 is not associated with the remainder of plurality of predefined functions that is associated with one or more associated user applications.

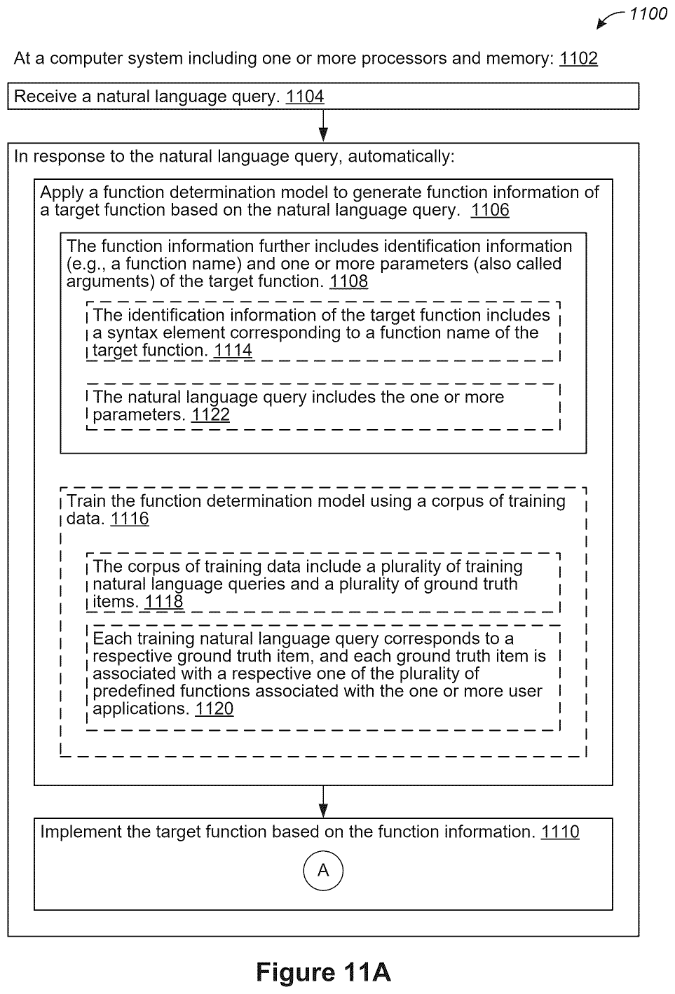

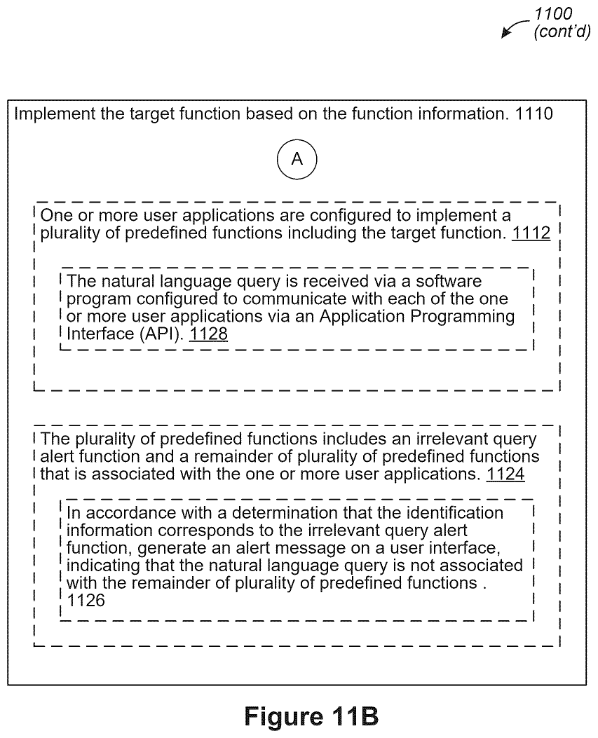

FIGS. 11A and 11B are a flow diagram of an example method 1100 of implementing a function automatically at a computer system 100, in accordance with some embodiments. Method 1100 is, optionally, governed by instructions that are stored in a non-transitory computer readable storage medium and that are executed (operation 1102) by one or more processors of the computer system 100. Each of the operations shown in FIG. 11 may correspond to instructions stored in the computer memory or computer readable storage medium (e.g., memory 506 of server(s) 102 in FIG. 5A, memory 556 of a client device 104 104 in FIG. 5B). The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. Some operations in method 1100 may be combined and/or the order of some operations may be changed.

A computer system 100 receives (operation 1104) a natural language query 106. In response to the natural language query 106, automatically, the computer system 100 applies (operation 1106) a function determination model 740 to generate function information 536 of a target function 108T based on the natural language query 106, and the function information 536 further includes (operation 1108) identification information 538 (e.g., a function name) and one or more parameters 540 (also called arguments) of the target function 108T. The computer system 100 implements (operation 1110) the target function 108T based on the function information 536. One or more user applications 122 are configured to implement (operation 1112) a plurality of predefined functions 108 including the target function 108T.

In some embodiments, the computer system 100 includes a client device 104 that receives the natural language query 106. The client device 104 locally applies the function determination model 740 to generate the function information 536 associated with the target function 108T.

In some embodiments, the computer system 100 includes a client device 104 that is communicatively coupled to a function server 102F, and the natural language query 106 is received by the client device 104 and provided to the function server 102F. The function server 102F applies the function determination model 740 to generate the function information 536 associated with the target function 108T.

In some embodiments, the identification information 538 of the target function 108T includes an index number identifying one of a plurality of syntax elements corresponding to a plurality of function names of the plurality of predefined functions 108. Alternatively, in some embodiments, the identification information 538 of the target function 108T includes (operation 1114) a syntax element corresponding to a function name of the target function 108T.

In some embodiments, the computer system 100 obtains a base language model and trains the base language model using a corpus of training data 405 to generate the function determination model 740.

In some embodiments, the computer system 100 trains (operation 1116) the function determination model 740 using a corpus of training data 405. The corpus of training data 405 include (operation 1118) a plurality of training natural language queries 914 and a plurality of ground truth items 916. Each training natural language query 914 corresponds (operation 1120) to a respective ground truth item 916, and each ground truth item 916 is associated with a respective one of the plurality of predefined functions 108 associated with the one or more user applications 122. Further, in some embodiments, the computer system 100 includes a client device 104 that is communicatively coupled to a function server 102F, and the function determination model 740 is trained at the function server 102F. In some embodiments, the computer system 100 trains the function determination model 740 further by generating a loss function based on a weighted combination of a plurality of loss terms. The plurality of loss terms includes a functional token term and one or more alternative terms distinct from the functional token term. The functional token term indicates an accuracy level of the identification information 538 of respective function information 536 generated for each training natural language query 914. A weight of the function toke term is greater than any other weight of a remainder of the plurality of loss terms. In some embodiments, after training the function determination model 740 using the corpus of training data 405, the computer system 100 freezing model weights of the function determination model 740 and injects trainable rank decomposition matrices into each layer of the function determination model 740.

In some embodiments, the computer system 100 starts an operation session in which the natural language query 106 is received, and context information associated with the natural language query 106 is not received during the operation session for generating the function information 536 associated with the target function 108T. In some embodiments, the function information 536 associated with the target function 108T is generated from the natural language query 106, independently of any other query distinct from the natural language query 106.

In some embodiments, the natural language query 106 includes (operation 1122) the one or more parameters 540.

In some embodiments, the function determination model 740 includes a large language model (LLM) configured to process the natural language query 106.

In some embodiments, the plurality of predefined functions 108 includes (operation 1124) an irrelevant query alert function and a remainder of plurality of predefined functions 108 that is associated with the one or more user applications 122. When the target function 108T is implemented, in accordance with a determination that the identification information 538 corresponds to the irrelevant query alert function, the computer system 100 generates (operation 1126) an alert message on a user interface, indicating that the natural language query 106 is not associated with the remainder of plurality of predefined functions 108.

In some embodiments, the computer system 100 executes a program 120 distinct from the one or more user applications 122, and displays a graphical user interface of the program 120. The natural language query 106 is received via the graphical user interface. In some embodiments, the natural language query 106 is received (operation 1128) via a software program 120 configured to communicate with each of the one or more user applications 122 via an API.

In some embodiments, the target function 108T includes a plurality of parallel functions. The computer system 100 implements the target function 108T by implementing each of the plurality of parallel functions by a respective distinct user application identified by respective identification information 538 and based on a subset of respective one or more parameters 540 of the respective parallel function.

In some embodiments, the target function 108T includes a first function and a second function nested in the first function. The computer system 100 implements the target function 108T by implementing the second function to generate an intermediate parameter and implementing the first function using the intermediate parameter.

In some embodiments, the one or more user application includes a first application initiated and executed to implement the target function 108T in response to the natural language query 106, and the function information 536 further includes application information identifying the first application.

In some embodiments, each of the one or more user applications 122 is configured to implement a set of respective functions. The plurality of predefined functions 108 include the set of respective functions. The function determination model 740 is trained to generate function information 536 of each of the plurality of predefined functions 108.

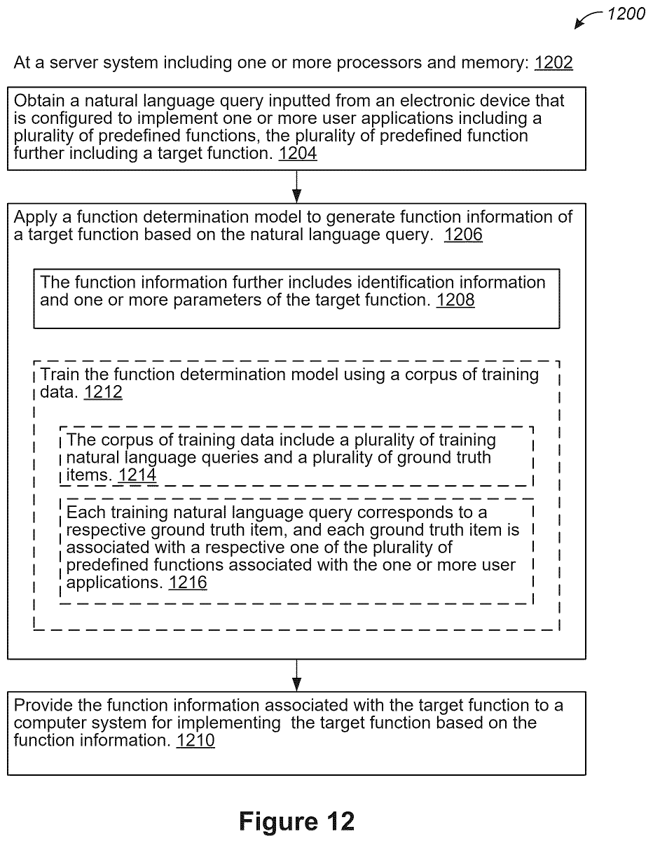

It should be understood that the particular order in which the operations in FIG. 11 have been described are merely exemplary and are not intended to indicate that the described order is the only order in which the operations could be performed. One of ordinary skill in the art would recognize various ways to reorder the operations described herein. Additionally, it should be noted that details of other processes described herein with respect to method 1100 are also applicable in an analogous manner to method 1200 described below with respect to FIG. 12. For brevity, these details are not repeated here.

FIG. 12 is a flow diagram of an example method 1200 of implementing a function automatically at a server 102 (e.g., a function server 102F), in accordance with some embodiments. Method 1200 is, optionally, governed by instructions that are stored in a non-transitory computer readable storage medium and that are executed (operation 1202) by one or more processors of the server 102. Each of the operations shown in FIG. 12 may correspond to instructions stored in the computer memory or computer readable storage medium (e.g., memory 506 of server(s) 102 in FIG. 5A). The computer readable storage medium may include a magnetic or optical disk storage device, solid state storage devices such as Flash memory, or other non-volatile memory device or devices. The computer readable instructions stored on the computer readable storage medium may include one or more of: source code, assembly language code, object code, or other instruction format that is interpreted by one or more processors. Some operations in method 1200 may be combined and/or the order of some operations may be changed.

The server 102 obtains (operation 1204) a natural language query 106 inputted from an electronic device (e.g., a client device 104) that is configured to implement one or more user applications 122 including a plurality of predefined functions 108. The plurality of predefined functions 108 further include a target function 108T. The server 102 applies (operation 1206) a function determination model 740 to generate function information 536 associated with the target function 108T, and the function information 536 further includes (operation 1208) identification information 538 and one or more parameters 540 of the target function 108T. The server 102 provides (operation 1210) the function information 536 associated with the target function 108T to a computer system 100 (e.g., a client device 104, an application server 102A, or a combination thereof) for implementing the target function 108T based on the function information 536.

In some embodiments, the electronic device (e.g., a client device 104) receives the natural language query 106, and provides the natural language query 106 to the server 102.

In some embodiments, the server 102 obtains a base language model and trains the base language model using a corpus of training data 405 to generate the function determination model 740.

In some embodiments, the server 102 trains (operation 1212) the function determination model 740 using a corpus of training data 405. The corpus of training data 405 include (operation 1214) a plurality of training natural language queries 914 and a plurality of ground truth items 916. Each training natural language query 914 corresponds (operation 1216) to a respective ground truth item 916, and each ground truth item 916 is associated with a respective one of the plurality of predefined functions 108 associated with the one or more user applications 122.

In some embodiments, the client device 104 executes a program 120 distinct from the one or more user applications 122, and displays a graphical user interface of the program 120. The client device 104 receives the natural language query 106 via the graphical user interface. The program 120 is configured to communicate with each of the one or more user applications 122 via an API.

In some embodiments, the target function 108T includes a plurality of parallel functions. Each of the plurality of parallel functions is implemented by a respective distinct user application identified by respective identification information 538 and based on a subset of respective one or more parameters 540 of the respective parallel function.

In some embodiments, incorporating function information directly into the context is unnecessary, as the function determination model 740 has already learned to map functional tokens 720 to corresponding function descriptions, thereby conserving a significant number of tokens 720 for processing. Given its compact size and the brevity of the context required, the function determination model 740 demonstrates a reduced latency (e.g., 0.38 seconds). In some embodiments, benchmark settings used for Llama7B evaluation include incorporating flash attention and not using quantization, and are applied to evaluate the function determination model 740, thereby maintaining an equitable comparison. In some embodiments, the function determination model 740 is deployed on mobile devices through quantization, e.g., by quantizing weights of the model 740 based on a precision setting of each mobile device. The function determination model 740 achieves remarkable performance, e.g., completing a function call within 1.1 to 1.7 seconds for typical queries of 20 to 30 tokens using a standard Android phone. In some embodiments, a function 108 can be encapsulated into a functional token 720, which is a novel token type seamlessly integrated into both a tokenizer and the function determination model 740. This model 740, through a cost-effective training process, facilitates deployment of Al agents characterized by remarkably low latency and high accuracy.

In some embodiments, for application developers of individual user applications 122 (e.g., DoorDash, Yelp, and Uber), the function determination model 740 paves the way for training on application-specific scenarios. Developers can pinpoint the APIs most utilized by their audience, transform these into functional tokens for the function determination model 740, and proceed with deployment This strategy has the capacity to fully automate application workflows with significantly enhanced response speeds and accuracy levels. Furthermore, the function determination model 740 is applied in operating systems of personal computers, smartphones, and wearable technology. Software developers could train minor LoRAs specific to each operating system. By accumulating multiple LoRAs, the function determination model 740 facilitates efficient function calling across diverse system components. For instance, incorporating this model into the Android ecosystem would enable developers of individual user applications 122 to train distinct LoRAs, enabling the function determination model 740 operational on mobile platforms.

In some embodiments, the function determination model 740 is applied on the cloud, vastly outpacing a conventional language model (e.g., model 112A) in speed metrics. In some embodiments, the function determination model 740 is dedicated to on-device reasoning, offering a valuable solution for users mindful of privacy or operational costs. By these means, the function determination model 740 may be applied across cloud and local environments, and cater to diverse user preferences for speed, efficiency, privacy and/or cost saving.

Memory is also used to store instructions and data associated with the methods 1100 and 1200, and includes high-speed random access memory, such as DRAM, SRAM, or other random access solid state memory devices; and, optionally, includes non-volatile memory, such as one or more magnetic disk storage devices, one or more optical disk storage devices, one or more flash memory devices, or one or more other non-volatile solid state storage devices. The memory, optionally, includes one or more storage devices remotely located from one or more processing units. Memory, or alternatively the non-volatile memory within memory, includes a non-transitory computer readable storage medium. In some embodiments, memory, or the non-transitory computer readable storage medium of memory, stores the programs, modules, and data structures, or a subset or superset for implementing methods 1100 and 1200.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, the memory, optionally, stores a subset of the modules and data structures identified above. Furthermore, the memory, optionally, stores additional modules and data structures not described above.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

What is claimed is:

1. A method for implementing functions automatically, comprising:
at a computer system including one or more processors and memory:
receiving a natural language query; and
in response to the natural language query, automatically:
applying a function determination model to generate function information of a target function based on the natural language query, the function information further including identification information and one or more parameters of the target function; and
implementing the target function based on the function information;
wherein one or more user applications are configured to implement a plurality of predefined functions including the target function.

2. The method of claim 1, the computer system including a client device that receives the natural language query, the method further comprising:
locally applying, by the client device, the function determination model to generate the function information associated with the target function.

3. The method of claim 1, wherein the computer system includes a client device that is communicatively coupled to a function server, and the natural language query is provided to the function server, further comprising:
applying, by the function server, the function determination model to generate the function information associated with the target function.

4. The method of claim 1, wherein the identification information of the target function includes an index number identifying one of a plurality of syntax elements corresponding to a plurality of function names of the plurality of predefined functions.

5. The method of claim 1, wherein the identification information of the target function includes a syntax element corresponding to a function name of the target function.

6. The method of claim 1, further comprising:
obtaining a base language model configured to process natural language queries; and
training the base language model using a corpus of training data to generate the function determination model.

7. The method of claim 1, further comprising training the function determination model using a corpus of training data;
wherein the corpus of training data include a plurality of training natural language queries and a plurality of ground truth items; and
wherein each training natural language query corresponds to a respective ground truth item, and each ground truth item is associated with a respective one of the plurality of predefined functions associated with the one or more user applications.

8. The method of claim 7, wherein:
training the function determination model further comprises generating a loss function based on a weighted combination of a plurality of loss terms;
the plurality of loss terms including a functional token term and one or more alternative terms distinct from the functional token term;
the functional token term indicates an accuracy level of the identification information of respective function information generated for each training natural language query; and
a weight of the function toke term is greater than any other weight of a remainder of the plurality of loss terms.

9. The method of claim 7, further comprising, after training the function determination model using the corpus of training data:
freezing model weights of the function determination model; and
injecting trainable rank decomposition matrices into each layer of the function determination model.

10. The method of claim 1, further comprising initiating an operation session in which the natural language query is received, wherein context information associated with the natural language query is not received during the operation session for generating the function information associated with the target function.

11. The method of claim 1, wherein the function information associated with the target function is generated from the natural language query, independently of any other query distinct from the natural language query, and wherein the function determination model includes a large language model (LLM) configured to process the natural language query.

12. The method of claim 1, wherein the natural language query includes the one or more parameters, and the natural language query is received via a software program configured to communicate with each of the one or more user applications via an Application Programming Interface (API).

13. The method of claim 1, wherein the plurality of predefined functions includes an irrelevant query alert function and a remainder of plurality of predefined functions that is associated with the one or more user applications, and implementing the target function further comprises:
in accordance with a determination that the identification information corresponds to the irrelevant query alert function, generating an alert message on a user interface, indicating that the natural language query is not associated with the remainder of plurality of predefined functions.

14. The method of claim 1, further comprising:
executing a program distinct from the one or more user applications; and
displaying a graphical user interface of the program, wherein the natural language query is received via the graphical user interface.

15. The method of claim 1, wherein the target function includes a plurality of parallel functions, and implementing the target function further comprises:
implementing each of the plurality of parallel functions by a respective distinct user application identified by respective identification information and based on a subset of respective one or more parameters of the respective parallel function.

16. The method of claim 1, wherein the target function includes a first function and a second function nested in the first function, and implementing the target function further comprises:
implementing the second function to generate an intermediate parameter; and
implementing the first function using the intermediate parameter.

17. The method of claim 1, wherein the one or more user application includes a first application initiated and executed to implement the target function in response to the natural language query, and the function information further includes application information identifying the first application.

18. The method of claim 1, wherein:
each of the one or more user applications is configured to implement a set of respective functions;
the plurality of predefined functions include the set of respective functions; and
the function determination model is trained to generate function information of each of the plurality of predefined functions.

19. A computer system, comprising:
one or more processors; and
memory having instructions stored thereon, which when executed by the one or more processors cause the processors to:
receive a natural language query; and
in response to the natural language query, automatically:
apply a function determination model to generate function information of a target function based on the natural language query, the function information further including identification information and one or more parameters of the target function; and
implement the target function based on the function information;
wherein one or more user applications are configured to implement a plurality of predefined functions including the target function.

20. A non-transitory computer-readable storage medium, having instructions stored thereon, which when executed by one or more processors of a computer system cause the processors to:
receive a natural language query; and
in response to the natural language query, automatically:
apply a function determination model to generate function information of a target function based on the natural language query, the function information further including identification information and one or more parameters of the target function; and
implement the target function based on the function information;
wherein one or more user applications are configured to implement a plurality of predefined functions including the target function.
